(19) United States
(12) Patent Application Publication
(10) Pub. No.: US 2009/0106037 A1
(43) Pub. Date: Apr. 23, 2009

(54) ELECTRONIC BOOK LOCATOR

(75) Inventor: Rajmohan Harindranath, Palakkad (IN)

Correspondence Address: KLARQUIST SPARKMAN, LLP, 121 SW SALMON STREET, SUITE 1600, PORTLAND, OR, 97204, US

(73) Assignee: Infosys Technologies Ltd., Bangalore (IN)

(21) Appl. No.: 11/951,147

(22) Filed: Dec. 5, 2007

(30) Foreign Application Priority Data
Oct. 23, 2007 (IN) 2400/CHE/2007

(51) Int. Cl. G06Q 50/00

(52) U.S. Cl. 705/1

(57) ABSTRACT

An electronic book locator can be a hand-held or a mounted device for locating or cataloguing books. One or more images of book spines can be processed using character recognition methods to electronically recognize book identification information appearing on the book spine. Locations of books in a book storage area can be determined from images of the books in the book storage area. Determined book locations can be compared to designated locations and misplaced books can be indicated. A book database can be generated based on images of books. Identification information of a target book can be input into a book locator device and a location of the target book can be indicated by the device.

### BACKGROUND

Libraries and other storage facilities store and inventory hundreds to thousands of books and other items. Current methods for cataloging and locating items in such facilities often require items to be tagged with address codes. However, the application of such tags can be costly, unreliable, and time and labor intensive. In addition, books and other items are often moved around or misplaced by users of these facilities making it extremely difficult to locate an item once it is not found in a designated location.

The current state of the art lacks suitable systems that can inventory and locate books and other items in storage facilities without the need for tags.

### SUMMARY

An electronic book locator can be a hand-held or a mounted device for locating, listing, or cataloguing books. One or more images of books in a storage area can be processed using character recognition methods to electronically recognize book identification information appearing on surfaces of the books. Locations of books in a storage area can be determined based on images of the books in the storage area. A book database can be generated from electronically recognized book identification information and determined book locations. Identification information of a target book can be input into a book locator device and a location of the target book can be indicated by the device. Determined book locations can be compared to designated book locations and misplaced books can be indicated. Described systems and devices can be applied to items other than books, such as videos, CDs, DVDs, grocery products, etc., that may benefit from electronic systems and methods for locating, listing, and cataloguing.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary system implementing a character recognition system.

FIG. 2 is a flowchart of an exemplary method of providing identification information of an item in a storage area.

FIG. 3 is a block diagram of an exemplary electronic locator system.

FIG. 4 is a flowchart of an exemplary method of indicating locations of items in a storage area.

FIG. 5 is a block diagram of an exemplary electronic locator system.

FIG. 6 is a flowchart of an exemplary method of indicating locations within images and locations within a storage area.

FIG. 7 is a block diagram of an exemplary electronic locator system.

FIG. 8 is a block diagram of an exemplary electronic locator system.

FIG. 9 is a flowchart of an exemplary method of providing an indication of whether a target book is in an image.

FIG. 10 is a flowchart of an exemplary method of providing an indication of a location of a target book based on a determination of whether the target book is in an image.

FIG. 11 is a flowchart of an exemplary method of indicating whether a target book is located in a first portion of a book storage area based on electronically recognized titles of books in the book storage area.

FIG. 12 is a block diagram of an exemplary database generator.

FIG. 13 is a flowchart of an exemplary method for storing book identification information.

FIG. 14 is a flowchart of an exemplary method for storing book identification information and determined book locations.

FIG. 15 is a block diagram of an exemplary library audit system.

FIG. 16 is a flowchart of an exemplary method for indicating whether a stored designated location corresponds to a determined location.

FIG. 17 is a block diagram of an exemplary book replacement assistance system.

FIG. 18 is a flowchart of an exemplary method for indicating whether a book is misplaced.

FIG. 19 is a block diagram of an exemplary suitable computing environment for implementing the technologies described herein.

FIG. 20 is a block diagram of an exemplary computing environment for implementing an electronic locator device.

FIG. 21 is a sample graphical user interface that can be used for inputting book identification information by a user.

FIG. 22 is a sample graphical user interface that can be used for providing an address of a book to a user.

FIG. 23 is a sample graphical user interface that can be used for indicating a location of a book on a floor plan of a storage area.

FIG. 24 is a sample graphical user interface that can be used for providing addresses of misplaced books to a user.

FIG. 25 is a block diagram of a basic book locator with optional RFID.

FIG. 26 is a block diagram of a book locator with automatic sort and with optional RFID.

### DETAILED DESCRIPTION

### Example 1

### Exemplary Character Recognition System

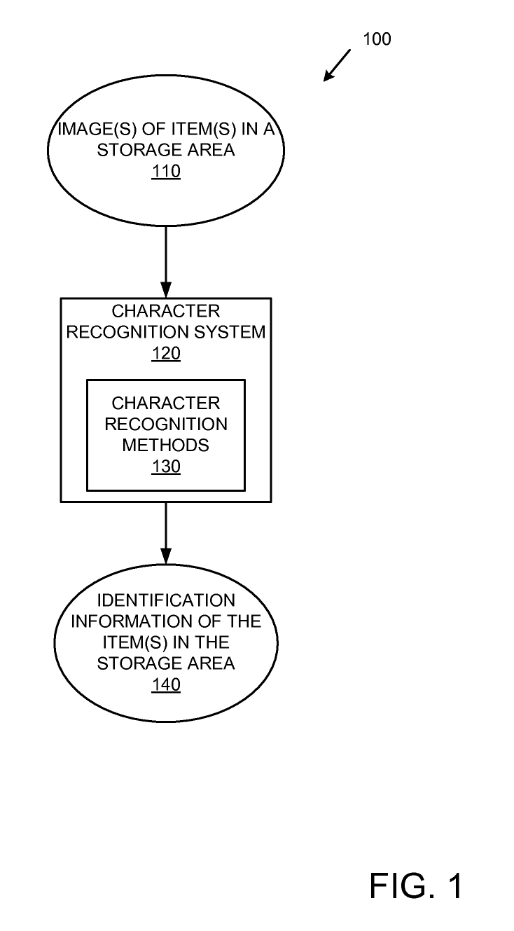

FIG. 1 is a block diagram of an exemplary system 100 implementing a character recognition system 120. The system 100 and variants of it can be used in methods described herein.

In the example, the character recognition system 120 accepts image(s) 110 of item(s) in a storage area. The image(s) 110 are processed using character recognition methods 130 to electronically recognize identification information appearing on the item(s) in the storage area. For example, the image(s) can be of characters or groups of characters such as words appearing on surfaces of the item(s). The recognized identification information of the item(s) 140 is provided.

In practice, the system 100 can be more complicated, with additional inputs, outputs, and the like.

### Example 2

### Exemplary Method of Providing Identification Information of an Item

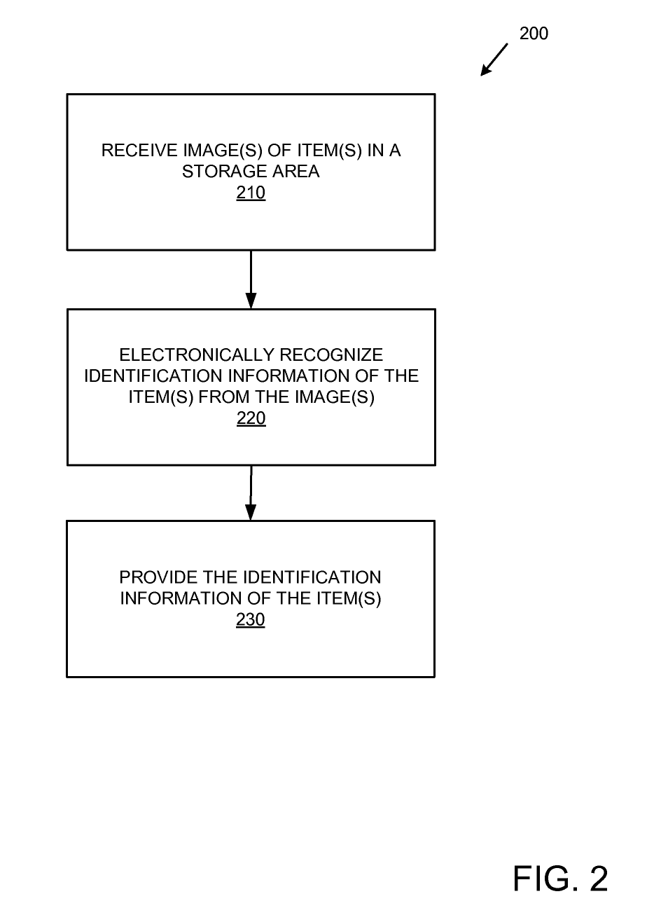

FIG. 2 is a flowchart of an exemplary method 200 of providing identification information of an item. Method 200 can be used in the examples described herein.

At 210, image(s) of item(s) in a storage area are received.

At 220, identification information of the item(s) is electronically recognized from the image(s). For example, titles of books can be electronically recognized from images of spines of books located in the storage area.

At 230, identification information of the item(s) is provided. For example, the title of the book can be displayed on a monitor.

The described actions can be performed by a character recognition system, a plug to the character recognition system, or both.

### Example 3

### Exemplary Electronic Locator System

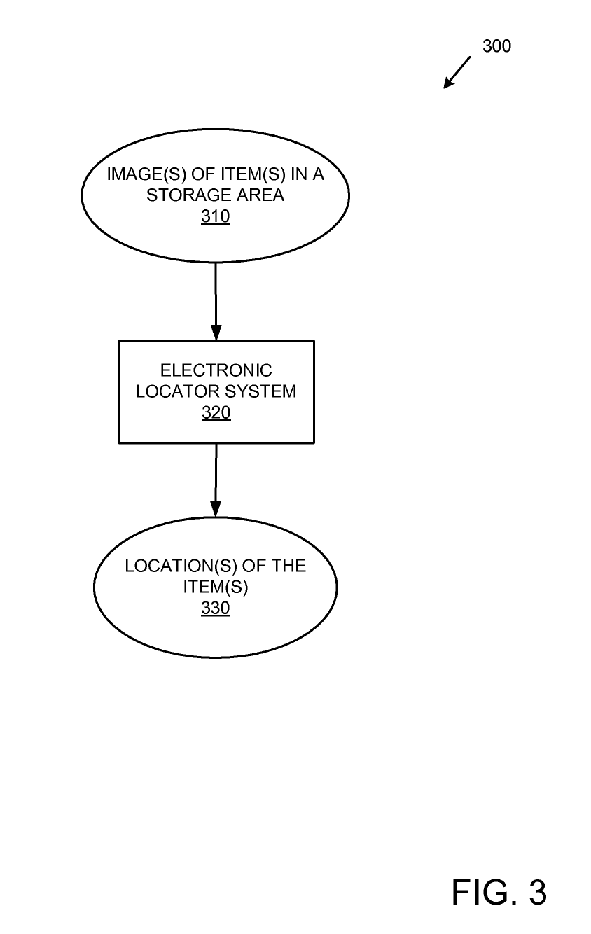

FIG. 3 is a block diagram of an exemplary system 300 implementing an electronic locator system 320. The system 300 and variants of it can be used in methods described herein.

In the example, image(s) of items in a storage area 310 are received by the electronic locator system 320, which processes the image(s) to determine location(s) for the item(s) 330. In practice, the system 300 can be more complicated, with additional inputs, outputs, and the like.

### Example 4

### Exemplary Method of Indicating Locations of Item (s) in a Storage Area

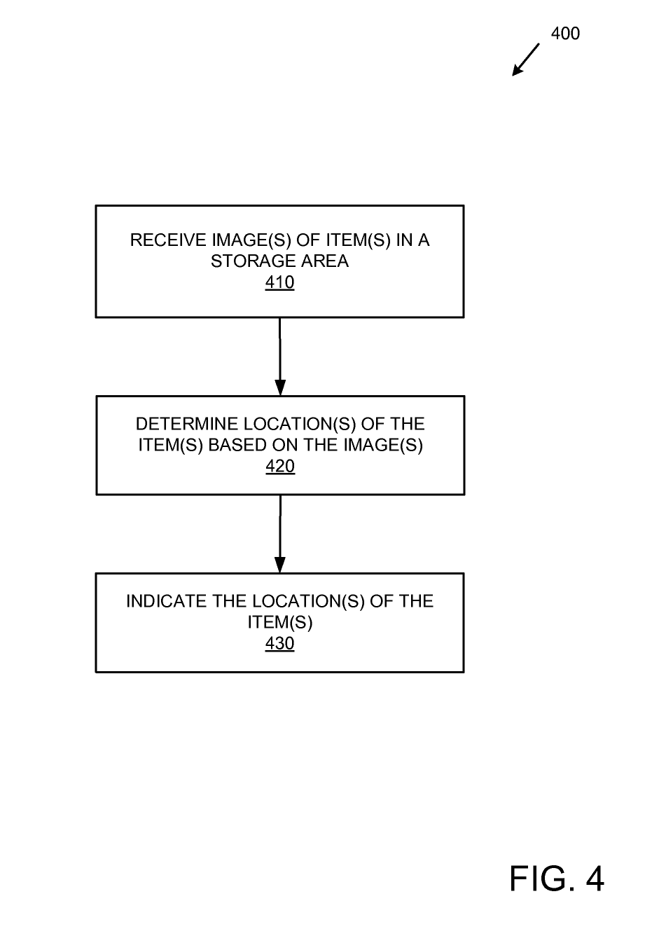

FIG. 4 is a flowchart of an exemplary method 400 of indicating locations of items in a storage area. Method 400 can be used in the examples described herein.

At 410, images of the items in the storage area are received.

At 420, locations for the items are determined based on the images.

At 430, the locations of the items in the storage area are indicated. For example, the location can be indicated according to any of the exemplary indications of a location described herein.

The described actions can be performed by an electronic locator system, a plug to the electronic locator system, or both.

### Example 5

### Exemplary Items

In any of the examples herein, an item can be any three-dimensional item. Items can be various shapes, sizes, and colors. Exemplary items include books, videos, CDs, DVDs, and grocery products. Items can be located in a storage area or other facility where the items can be arranged, stored, and accessed.

In any of the examples herein, items do not need to be prepared for storage such as through labeling with item specific codes or symbols. For example, items do not need to have tags applied. Exemplary tags include library call number labels, RFID tags, and barcodes. The methods described herein can be used in parallel with or combined with systems and methods using tags. However, tagless items and tag-free electronic recognition can be supported. For example, using the methods described herein, a book in a library does not need to be labeled with a call number or an address code. By using the technologies described herein, labor-intensive, costly, and error-prone tagging and labeling systems can be avoided.

### Example 6

### Exemplary Storage Area

In any of the examples herein, storage areas can be facilities where items can be located. Items can be arranged, stored, and accessed in a storage area. Items can be placed in a storage area according to an organizational or catalog system and items can have a designated location in a storage area. Items can be arranged in groups, located adjacent to other items, stacked, or placed on shelves in a storage area.

Items such as books can be located in a library and arranged on shelves or in storage racks such that the spines of the books are visible and accessible. Books can also be located in a book store or a second-hand book store. Videos can be located in a video store or video library and arranged such that the title of the video is visible. Grocery items can be located in a grocery store, supermarket, warehouse, or other storage area and arranged such that product identification information can be visible.

### Example 7

### Exemplary Identification Information of an Item

In any of the examples herein, identification information of an item is information that describes the item and that can be used either alone or in combination with other information to identify the item. For example, identification information for a book can include title, author, publisher, date of publication, subject, keyword, number of pages, and/or ISBN number. Exemplary identification information for a DVD or video can include title, director, featured actors, movie duration, movie release date, genre, and/or advisory rating. For items in a grocery store or grocery storage area, exemplary identification information can include type of product, ingredients, producer, size, weight, and/or volume. Item identification information can include a bar code or UPC code.

Identification information of an item can appear as text on an external surface of the item such that the information can be readily observed. For example, identification information can be printed on the external surface of the item. Exemplary identification information of a book such as a book title can appear on the spine of the book, and the spine of the book can be readily observed when the book is shelved in a library or a store. Identification information of an item appearing on a surface of the item can be one or more strings or groups of characters, wherein characters include letters and/or numbers. The groups of characters can form words such as to spell out a title, a phrase, or a name. Character groups can be oriented substantially vertically, horizontally, or at other angles relative to a reference surface such as a shelf or a floor.

Identification information of an item can be a graphic or other image that appears on an external surface of the item. For example, identification information of a book can be a book cover graphic, a title written in a decorative font, or an image appearing on a spine of the book.

Although an item can be identified using various types of identification information, not all types of identification information are printed or appear on an external surface of the item. However, identification information appearing on an external surface of an item can appear in images of the item. Identification information of an item appearing in an image of the item can be electronically recognized using character recognition methods described herein.

Identification information of an item appearing on an external surface of the item need not be part of a tag. A tag can be an address tag that has been placed on an item, for example, when the item is being prepared to be catalogued or shelved. For example, in a library, books can be prepared for shelving through the application of a tag to a book spine, the tag indicating a call number. A title of a book is an example of book identification information that can be used in the examples described herein because a book title typically appears on a spine of a book and does not typically appear on a call number tag.

Identification information can be stored such as in a list, database, or other exemplary storage described herein. Stored identification information can be retrieved based on a search query.

### Example 8

### Exemplary Character Recognition Methods

In any of the examples herein, character recognition methods include methods for electronically recognizing characters from an image. Characters can be letters or numbers and groups of characters can correspond to words or phrases of printed or written text. Images of character groups can be translated into computer-editable text or digital character groups using character recognition methods. Digital character groups can be manipulated by a computer.

Exemplary character recognition methods include optical character recognition (OCR), intelligent character recognition (ICR), fuzzy OCR, fuzzy word matching algorithms, and other OCR based pattern recognition and matching algorithms. Character recognition methods can be implemented using conventional character recognition software and algorithms. Fuzzy OCR and fuzzy word matching algorithms can be configured to reference a database or other stored list of identification information.

Exemplary character recognition methods can include database-assisted OCR. For example, an image can be processed with OCR and a database or other stored list of item identification information can be referenced during the processing. Fuzzy word matching algorithms can use a database to match recognized item identification information with item identification information stored in the database. For example, database-assisted OCR can be performed on images of book titles by referencing a database of book titles. The book titles in the database can represent all books contained in a library and the database can be created using described character recognition methods. In this example, an image of a title of a book can be processed using OCR and the recognized title can be compared with the list of titles, such as by using fuzzy word matching algorithms, and a closest match can be determined.

Database-assisted character recognition methods can be based on images of items in a storage area that are stored in a database. The images can be stored with corresponding item identification information and/or item location information. Pattern matching algorithms can be used to match a stored image of an item to an image of a storage area containing the item. For example, images of book spines can be stored in a database. Pattern matching algorithms can be used to match an image of a spine of a book in a library to a stored image of the book spine. In some examples, titles appearing on book spines can be written using fonts which are quite rare, unusual, or difficult to recognize. In these examples, a book title may not be easily recognized using OCR. However, pattern matching can be used to match an image of the book title to an image in a database and a book title can be retrieved from the database based on results of the matching.

Character recognition methods are typically used to process images of one or more items to electronically recognize character groups appearing on one or more surfaces of the one or more items. For example, the item can be a book and the image can be of a spine of the book. The image of the book spine can be processed using character recognition methods to electronically recognize a book title appearing on the spine.

Character recognition methods can be modified based on types of items and arrangements of the items. Character recognition methods can be configured to recognize text using mixed layouts. For example, library shelves typically contain books orientated substantially perpendicular to a floor or shelf, with book spines oriented outwards as the most visible part of the books. Text or character groups appearing on the book spines can be printed along the spine or across the spine. A character recognition algorithm can be modified to primarily group characters in a perpendicular fashion to recognize text along the spine. Since the books can lean slightly on the shelves, the angles considered may not be strictly perpendicular. For example, an offset of +/−25° from perpendicular may be considered. In some situations, books can be oriented horizontally on a shelf. Therefore, character grouping can also be performed horizontally. When processing images of books in a library where most books are oriented perpendicular to a shelf, perpendicular character grouping can be performed initially. If the initial perpendicular character grouping doesn't result in the desired output or match, horizontal or other character grouping can be performed.

In some examples, an image capture device can be misaligned or otherwise oriented non-parallel to a floor or shelf. Character recognition methods can be modified, for example, to reorient captured images based on a known image capture device orientation angle or according to the orientation of a shelf or other indicator in the captured image.

### Example 9

### Exemplary Locations of an Item

In any of the examples described herein, a location of an item can be a location in a storage area, a location relative to another item, or a location within an image. For example, a location in a storage area can be indicated by address information. A relative location of an item can be indicated by a location that is adjacent to or proximate to other items. A location of an item within an image can be indicated on the image, wherein the image may or may not include address information.

A location of an item can be a determined location or a designated location. A determined location can be an actual physical location of the item such as a location determined from an image of the item in a storage area.

A designated location of an item can be a location where the item is most likely to be found, a location where the item was recently known to be located, a preferred location for the item, or a location where the item is designated to be located. A designated location can be a correct location for an item. A designated location for an item or a list of designated locations for one or more items can be stored in a database, on a hard drive, or other conventional storage means. A designated location can be indicated by a designated address. A designated address for an item or a list of designated addresses for one or more items can be stored. Designated locations for items can be sorted according to identification information of the items, or listed according to the identification information. Therefore, identification information of an item can be used to retrieve a stored designated location for the item based on the identification information. For example, a list can contain titles of books and designated locations for the books with the corresponding titles. In this example, providing a title for a book can be sufficient to retrieve a stored designated location for the book.

### Example 10

### Exemplary Indications of a Location

In any of the examples described herein, a location of an item can be indicated using various techniques. For example, a location of an item in a storage area can be indicated by providing an address of the item. An address of an item can include any information that specifies a location in a storage area. Providing an address of an item in a storage area to a user can enable the user to find the item in the storage area. Exemplary address information can include an aisle, column, row, storage rack, shelf number, or combination thereof. Address information can include coordinate information such as GPS coordinates or other coordinates that are specific to a coordinate system or organizational system of a storage area. An exemplary address can be “Aisle 25, Shelf C, Column 263.”

A location of an item can be provided or indicated without listing an aisle, shelf number, or other address information. For example, a location of an item can be indicated with visual or auditory cues. Exemplary visual cues include a displayed image, a flashing light, a directed or moving beam of light, and a stationary light source. Exemplary auditory cues include a recorded voice, audible beeps, and recorded directional commands.

A location of an item in a storage area can be illustrated such as by displaying a reproduction of a floor plan of the storage area, a map of the storage area, or other pictorial representation of the storage area. For example, a location of an item can be indicated by a graphic (e.g. dot) placed on an illustration of a storage area. A location of an item can be indicated on an image of a portion of a storage area where a target item is located by indicating or distinguishing the target item from other items in the image.

A location of an item in a storage area can be indicated by indicators located in the storage area. For example, aisle, row, or other address information in a storage area can be indicated by mounted lights such as LEDs that turn on and off to attract the attention of a user. In other examples, a beam of light such as that from a laser pointer can be used to direct a user to a location in a storage area.

A location of an item in a storage area can be indicated using auditory cues. For example, a speaker can play a spoken address of an item or a recorded voice that otherwise directs a user to a location in a storage area. A speaker can provide commands that direct a user to a location such as by playing commands that direct a user to turn right or left. The commands can be pre-recorded spoken commands. A speaker can provide non-voice auditory cues. For example, an output device can produce an audible beeping that increases in frequency as a user approaches a location. Such auditory cues can be provided by a portable device or a stationary device. For example, the auditory cues can be provided to one or more users as they walk through a storage facility. The auditory cues can be sourced at or near a location of an item or at a portable device.

A location of an item in a storage area can be indicated by providing a location of the item within an image of the storage area. For example, a location of a book in a library can be indicated by displaying an image or picture of the location to one or more users. In this example, the one or more users can recognize the location of the book in the library based on viewing the image. Indications of a location of an item within an image can include indicating a group of pixels in the image that correspond to the item. An item can be circled or otherwise highlighted in an image to indicate a location of the item within the image. An image can contain address information for an item that one or more users can use to locate the item in a storage area.

Indications of a location of an item can be combinations of exemplary indications described herein.

### Example 11

### Exemplary Location Determination Methods

In any of the examples described herein, a location of an item can be determined using various methods. A location of an item within an image can be determined using pattern recognition and matching methods such as the exemplary character recognition methods described herein. The location of an item in a storage area can be determined based on an image of the item in the storage area such as by mapping the location of the item within the image to a physical location in the storage area. A location of an item can be input by a user.

A location of an item within an image can be determined by processing the image using character recognition methods described herein. Character recognition methods can be used to electronically recognize identification information appearing in an image of the item. The identification information can be recognized from a portion of the image such as from a group of pixels. A location of an item within the image can be associated with the group of pixels. For example, for an image of three books A, B, and C, a location for book B within the image can be associated with those pixels in the image that were electronically recognized to contain a title of book B. The pixels that contain the text for a title of book C can be associated with a location within the image for book C.

A location within an image can be mapped to a physical location within a storage area. The mapping can be performed based on input information. A device can accept input data providing information on a physical location where an image is being captured (e.g. barcode, user input, GPS, and the like). For example, each aisle in a storage area can be labeled with a reference point such as a barcode or other printed label. The reference point can be imaged and recognized to provide location information. A user walking through the library with a mobile device can scan the reference point to provide location information to the device concerning a location where images are being captured. Alternatively, a user could enter information about a physical location into the device by typing or using another input device described herein.

A location within an image can be mapped to a physical location within a storage area based on a configuration of one or more image capture devices. For example, a camera mounted in a library can capture images of shelves A through D in the library. In this example, the camera can be stationary and an image from the camera of shelves A through D can have groups of pixels A through D that correspond to shelves A through D, respectively. In this manner, identification information electronically recognized from pixel group A can be associated with shelf A. The item corresponding to the recognized identification information can be labeled as located on shelf A. For a moving camera, such as a camera that scans a portion of the library, the camera movement can be correlated with a change in captured locations. In this example, pixel groups associated with locations in the storage area can change as a function of time.

A location of an item can be determined from an image of the item when the image includes address information. For example, an address can be written, printed, or otherwise indicated in portions of a storage area and the address can be determined from an image of the address using character recognition methods described herein. For example, a shelf of books in a library can be labeled with row and column numbers on a visible portion of the shelf. In this example, a captured image of the books on the shelf can contain the addresses of the books as indicated on the shelf. Therefore, the books and their corresponding addresses can appear in the same image.

A location of an item can be determined without address information. For example, using the technologies described herein, a location of a book in a library can be determined without using the call number or other information appearing on a tag that has been applied to a book spine.

### Example 12

### Exemplary Input Devices

In any of the examples described herein, input devices are devices used to input information into a system. Input devices can be a touch input device such as a keyboard, keypad, touch screen, mouse, pen, joystick, or trackball. An input device can be a voice input device, a voice recognition system, a scanning device, or any other device that provides input to a computing environment. For audio, input devices can be a sound card or similar device that accepts audio input in analog or digital form, or a CD-ROM reader that provides audio samples to a computing environment.

One or more input devices can be used or combined with other input devices. Input devices can be incorporated into a portable or handheld device or a stationary device such as a computer work station. An input device can be connected remotely to a system such as through a wireless connection, or an input device can be connected through a direct wireline.

Identification information of an item, as described herein, can be input into any of the systems described herein using an input device. Information input into an input device can be stored using typical data input software. An input device can be used to trigger a system to perform steps in a method.

### Example 13

### Exemplary Output Devices

In any of the examples described herein, an output device can provide information to one or more users. For example, an output device can provide an item address to a user. In other examples, an output device can indicate a location of an item. In other examples, an output device can indicate whether an item has been found or whether an item has been misplaced. In other examples, an output device can indicate whether an item is in a first portion of a storage area. In some examples, an output device can indicate whether an item is in an image. In some examples, an output device can indicate whether a designated location corresponds to a determined location.

Output devices can be incorporated into a portable or handheld device or a stationary system such as a computer work station. Output devices can be located, mounted, or distributed in a storage area. A combination of output devices can be used or incorporated into a single device. Output devices can use visual or auditory cues to provide information to a user.

Exemplary output devices include an LCD, computer monitor, a directional light source, a mounted light source, an LED, a laser pointer, a touch screen, a TV, and a speaker. Output devices can be a software-driven user interface such as a display device connected to a computer system. Output devices can be a printer, CD-writer, or another device that provides output from a computing environment.

### Example 14

### Exemplary Image Capture Devices

In any of the examples herein, an image capture device can be any device capable of capturing an image. Examples of such devices include digital cameras, video cameras, and scanners. Image capture devices can be handheld, portable, stationary, movable, positioned in fixed locations, or configured for optional mechanized movement.

An image capture device can be connected to a computer, server, an image capture control device, or other device through a direct line or through wireless transfer mechanisms. Such connections can be used to control movement of an image capture device, to activate image capture, and to transfer images. For example, image capture devices can be activated and controlled through an external trigger from a computer. In the case of a digital camera image capture device, conventional camera controller software can be used to activate the camera. Image capture devices can be configured to capture images on a predetermined schedule or can be activated and controlled based on user input.

One or more image capture devices can be mounted in several locations within a storage area. Mounted image capture devices can be positioned such that substantially all portions of a storage area can be captured by the image capture devices. Mounted image capture devices can be configured to scan a portion of a storage area.

An image capture device can be movable and can capture images as the image capture device is moved through a storage area. A handheld image capture device can capture images as a user walks through a storage area, the user can be carrying, pushing, or otherwise transporting the device. One or more movable image capture devices can be configured to move through a storage area automatically while capturing images of the storage area.

### Example 15

### Exemplary Storage

In any of the examples herein, storage can be electronic storage for storing data. Exemplary storage can be databases, XML documents, or other structured systems for storing data. Storage can be used to store lists of item identification information, designated locations for items in storage areas, image data, and image capture device configurations.

### Example 16

### Exemplary Electronic Locator System

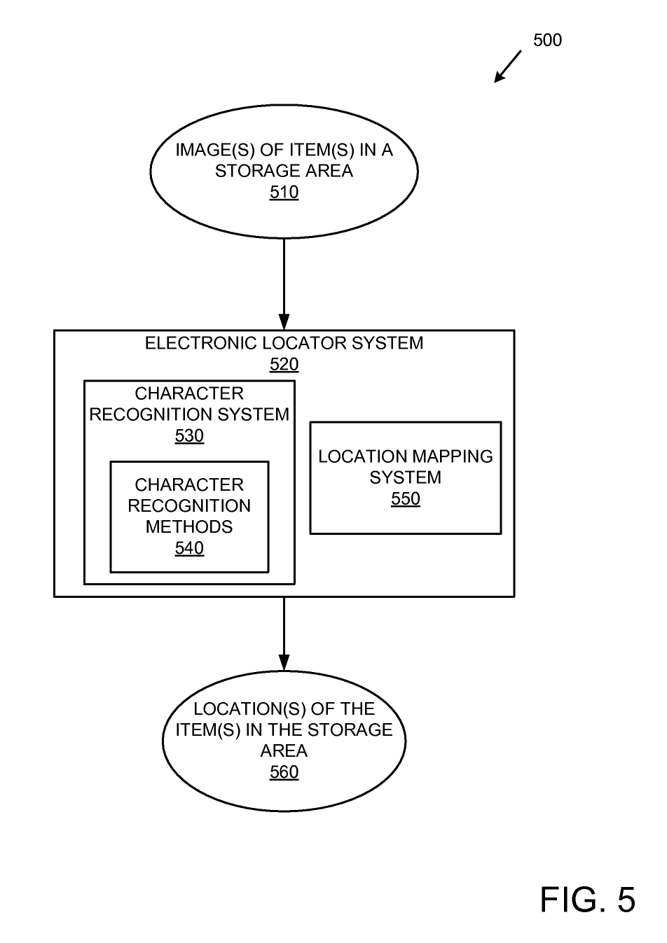

FIG. 5 is a block diagram of an exemplary system 500 implementing an electronic locator system 520.

The electronic locator system 520 receives image(s) 510 of item(s) in a storage area. A character recognition system 530 processes the image(s) using character recognition methods 540 described herein. The character recognition system 530 can electronically recognize identification information of the item(s) in the storage area and can determine location(s) of the item(s) within the image(s). The electronic locator system 520 can include a location mapping system 550. The location mapping system 550 can map the locations of the item(s) within the image(s) to locations in the storage area. The mapping can be based on additional input or on stored instructions or configurations.

The electronic locator system 520 provides the determined location(s) 560 of the item(s) in the storage area. For example, the electronic locator system 520 can indicate a location using exemplary indications described herein.

The electronic locator system 520 can provide or indicate a location of an item to one or more users. The electronic locator system 520 can determine locations for a plurality of items. For example, the electronic locator system 520 can provide a list of determined locations.

### Example 17

### Exemplary Method of Indicating Locations

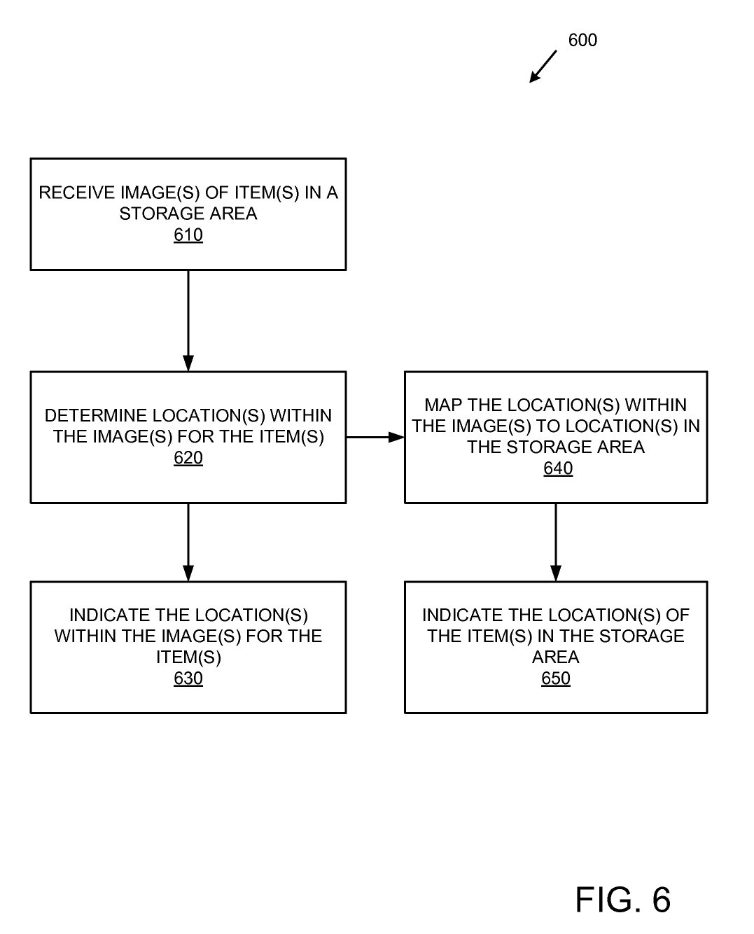

FIG. 6 is a flowchart of an exemplary method 600 of indicating locations of items within images and locations of items within a storage area, and can be used in any of the examples herein.

At 610, image(s) of item(s) in a storage area are received.

At 620, location(s) within the image(s) for the item(s) are determined. For example, a group of pixels of an image can correspond to a location of an item within an image. Character recognition methods can be used to determine the group of pixels based on item identification information recognized from the group of pixels.

At 630, the location(s) within the image(s) for the item(s) are indicated. For example, the image(s) can be displayed and a corresponding pixel group for an item can be outlined or otherwise indicated on the displayed image.

At 640, the location(s) within the image(s) for the item(s) are mapped to location(s) in the storage area. For example, the location(s) within the image(s) can be mapped to location(s) in the storage area based on information related to physical locations appearing in the image(s). In some examples, a pixel group corresponding to a location of an item within the image(s) can also correspond to a particular shelf number or other address information. In this example, the shelf number can be an address or part of an address that indicates a location of the item in the storage area.

At 650, the location(s) in the storage area for the item(s) are indicated. For example, an address indicating a location in a storage area can be provided.

### Example 18

### Exemplary Electronic Locator System

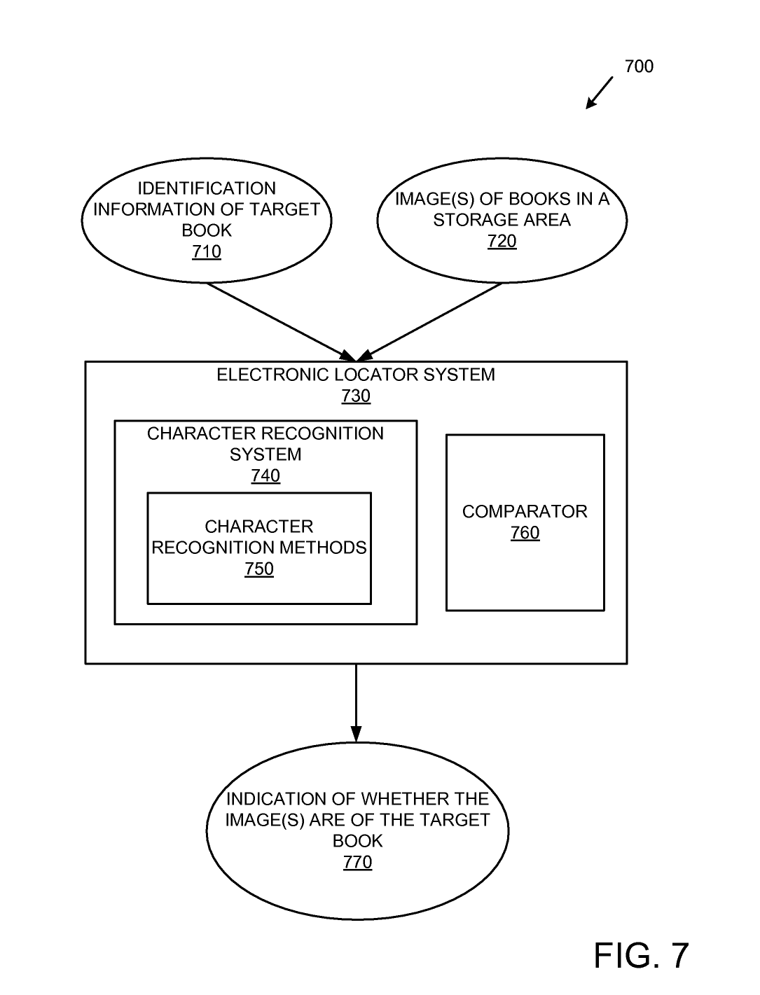

FIG. 7 is a block diagram of an exemplary system 700 implementing an electronic locator system 730.

The electronic locator system 730 receives identification information of a target book 710 and image(s) 720 of books in a storage area. The electronic locator system 730 processes the image(s) 720 using a character recognition system 740 and a comparator 760. The character recognition system 740 processes the image(s) 720 using character recognition methods 750 described herein to recognize identification information of the books in the image(s). The comparator 760 compares the identification information of the target book 710 to the recognized identification information of the books in the image(s). The electronic locator system 730 provides indications 770 of whether the target book is in the images based on the comparator 760 results. For example, if comparator 760 determines that the target identification information matches recognized identification information, then indications that the target book is in the image(s) are provided.

The electronic locator system 730 can assist one or more users in locating or finding a target book in a library or other book storage facility.

### Example 19

### Exemplary Electronic Locator System

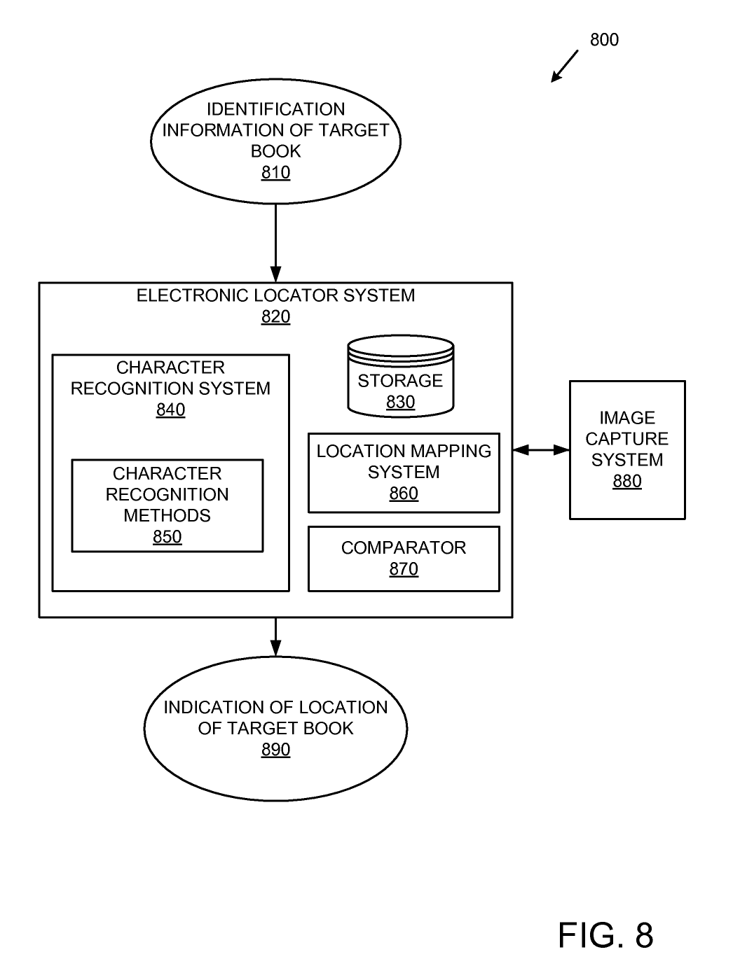

FIG. 8 is a block diagram of an exemplary system 800 implementing an electronic locator system 820.

The electronic locator system 820 receives identification information of a target book 810. An image capture system 880 provides image(s) of books in a storage area to the electronic locator system 820. The image capture system 880 can provide image(s) to the electronic locator system 820 by referencing a storage 830. For example, the storage 830 can contain a stored designated location for the target book and the image capture system 880 can provide image(s) of the designated location to the electronic locator system 820. The storage 830 can also be used to store images transferred from the image capture system 880.

The electronic locator system 820 processes the image(s) from the image capture system 880 based on the identification information 810 using a character recognition system 840, a location mapping system 860, and a comparator 870. The character recognition system 840 processes the image(s) using character recognition methods 850 described herein to electronically recognized identification information appearing on books in the image(s). The comparator 870 compares recognized identification information to the identification information of the target book. Whether the target book is in the image(s) can be determined based on the comparator 870 results.

The character recognition system 840 can determine a location of the target book within the image(s). The location mapping system 860 can map the location of the target book within the image(s) to a location of the target book within the storage area. The location mapping system 860 can reference image capture system configurations in the storage 830. Indications 890 of the location of the target book can be provided.

The electronic locator system 820 can assist one or more users in locating or finding a target book in a library or other book storage facility.

### Example 20

### Exemplary Method of Indicating Whether a Target Book is in an Image

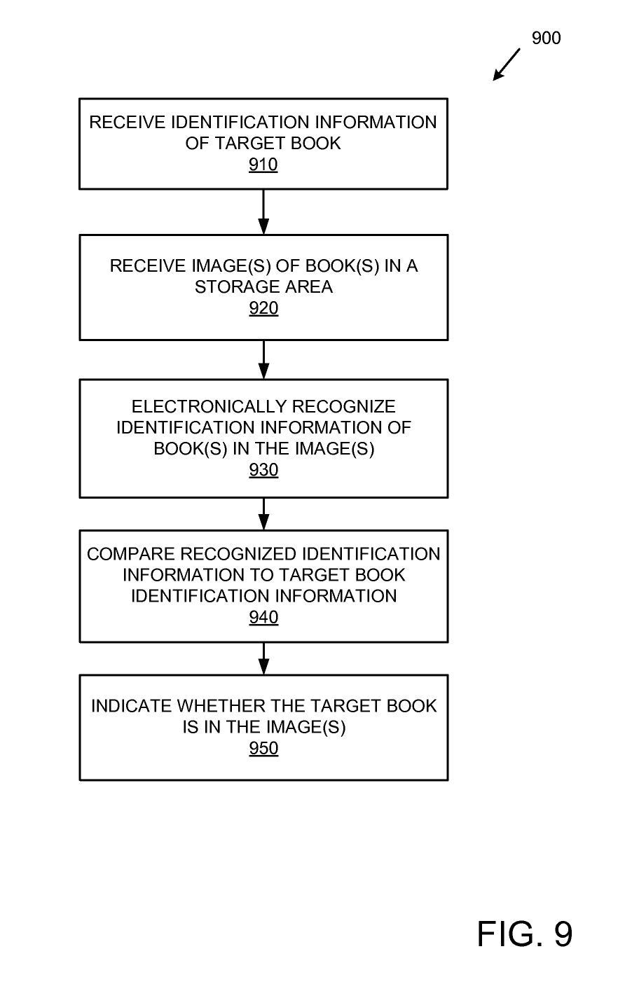

FIG. 9 is a flowchart of an exemplary method 900 of indicating whether a target book is in an image, and can be used in any of the examples herein.

At 910, identification information of a target book is received. For example, the identification information can be input by one or more users.

At 920, image(s) of book(s) in a storage area are received. For example, the target book can be located in the storage area.

At 930, identification information of the book(s) in the image(s) is electronically recognized using character recognition methods. For example, a title that appears on a book in the image can be electronically recognized.

At 940, recognized identification information is compared to target book identification information. For example, the target book title can be compared to electronically recognized titles of the books in the image(s).

At 950, the results of the comparison are indicated. For example, if there is a match between the recognized identification information and the target book identification information, then the target book is indicated to be in the image. If there is not a match, the target book is indicated as not in the image.

### Example 21

### Exemplary Method of Indicating a Location of a Target Book

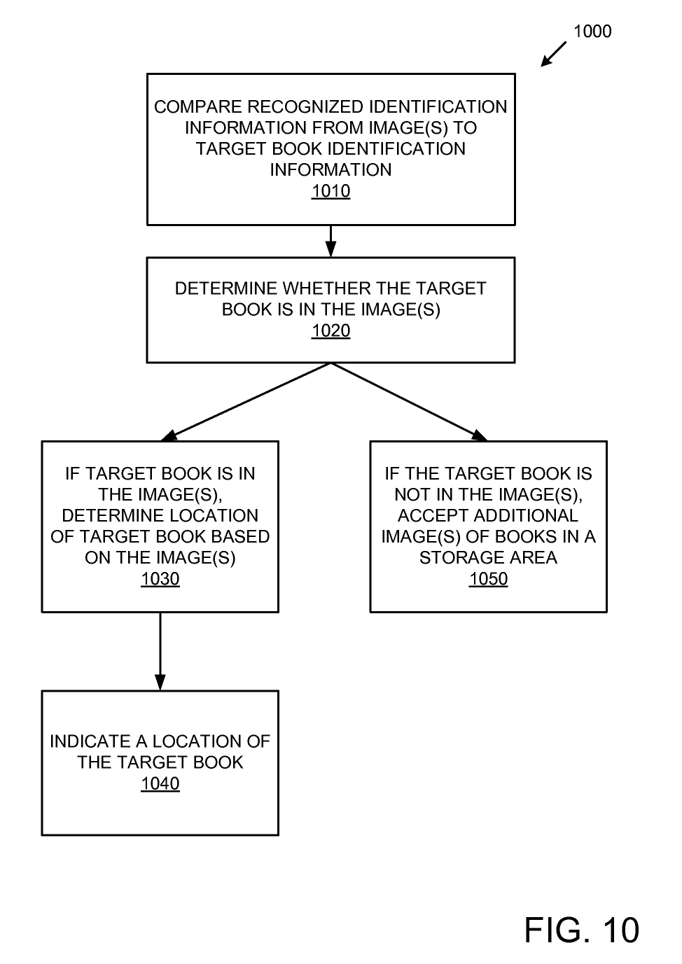

FIG. 10 is a flowchart of an exemplary method 1000 of indicating a location of a target book based on a determination of whether a target book is in an image, and can be used in any of the examples herein.

At 1010, recognized identification information from image(s) is compared to target book identification information.

At 1020, whether the target book is in the image(s) is determined. For example, method 900 can be used to provide an indication of whether the target book is in the image(s).

At 1030, if the target book is in the image(s), the location of the target book is determined based on the image(s). The location can be determined as in any examples described herein. At 1040, the determined location is indicated.

At 1050, if the target book is not in the image(s), additional image(s) of books in a storage area are accepted. For example, 920, 930, 940 of method 900 can be performed wherein the image(s) are the additional image(s), followed by method 1000 until the target book is determined to be in the additional image(s).

### Example 22

### Exemplary Method of Indicating Whether a Target Book is in an Image

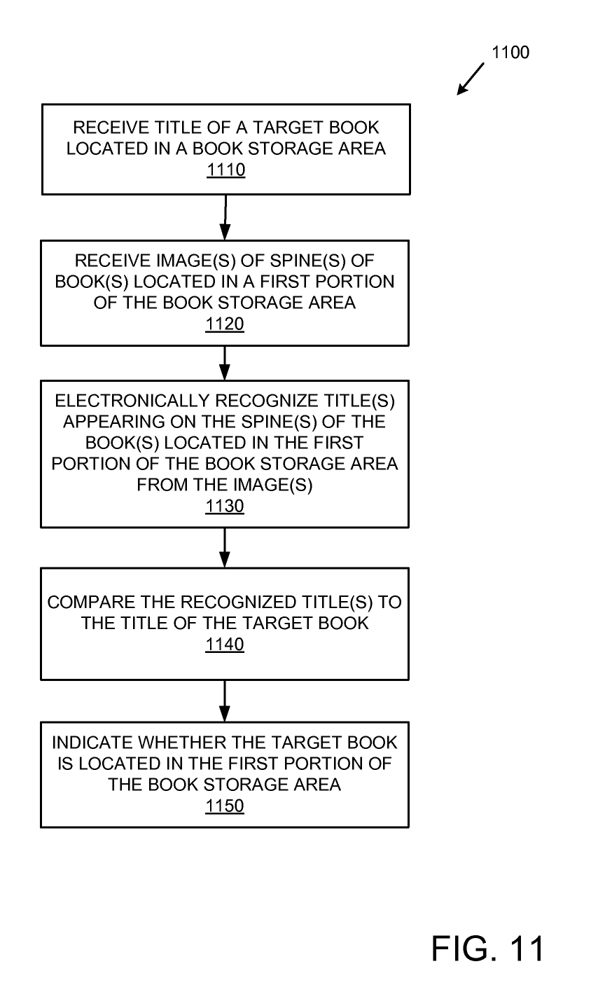

FIG. 11 is a flowchart of an exemplary method 1100 of indicating whether a target book is located in a first area of a book storage area based on electronically recognized titles of books in the book storage area, and can be used in any of the examples herein.

At 1110, a title of a target book located in a book storage area is received. For example, the title can be input by one or more users. Alternatively, the one or more users can input other book identification information and the title can be retrieved from a storage based on the input.

At 1120, image(s) of spine(s) of book(s) in a first portion of the book storage area are received. The books can be arranged on shelves with other books.

At 1130, title(s) appearing on the spine(s) of the book(s) located in the first portion of the book storage area are electronically recognized from the image(s) using character recognition methods.

At 1140, recognized title(s) are compared to the title of the target book.

At 1150, an indication of whether the target book is located in the first portion of the book storage area is provided. For example, if there is a match between a recognized book title and the target book title, then the target book is indicated to be located in the first portion of the book storage area.

### Example 23

### Exemplary Database Generator System

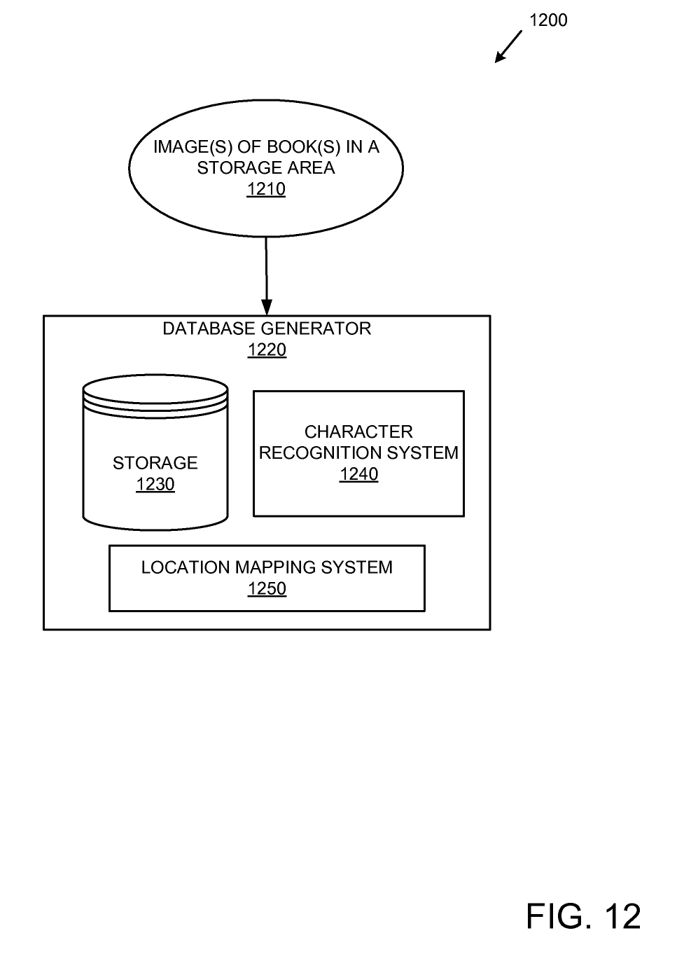

FIG. 12 is a block diagram of an exemplary system 1200 implementing a database generator 1220.

The database generator 1220 accepts image(s) 1210 of book(s) in a storage area. A character recognition system 1240 processes the image(s) to electronically recognize identification information appearing on the books in the image(s). The database generator 1220 stores the recognized identification information in a storage 1230. For example, titles of books can be recognized from the images, and the titles can be stored in a library catalog database.

The character recognition system 1240 can process the image(s) to determine locations of the books within the images. A location mapping system 1250 can map the locations of the books within the image(s) to locations of the books in the storage area. The database generator 1220 can store determined locations in the storage 1230.

Database generator 1220 can be used to inventory a storage area or to generate a list of item identification information and corresponding item locations. For example, database generator 1220 can generate and store a list of designated locations.

### Example 24

### Exemplary Method of Storing Book Identification Information

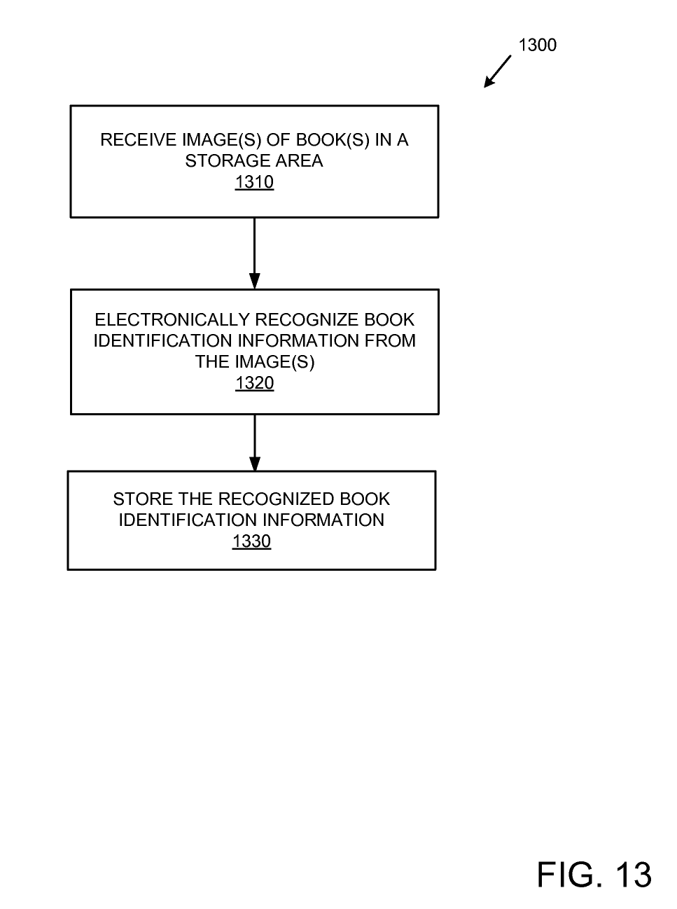

FIG. 13 is flowchart of an exemplary method 1300 of storing book identification information that can be used in any of the examples herein.

At 1310, image(s) of book(s) in a storage area are received.

At 1320, identification information of the book(s) in the image(s) is electronically recognized from the image(s).

At 1330, book identification information is stored.

### Example 25

### Exemplary Method of Storing Identification Information and Locations

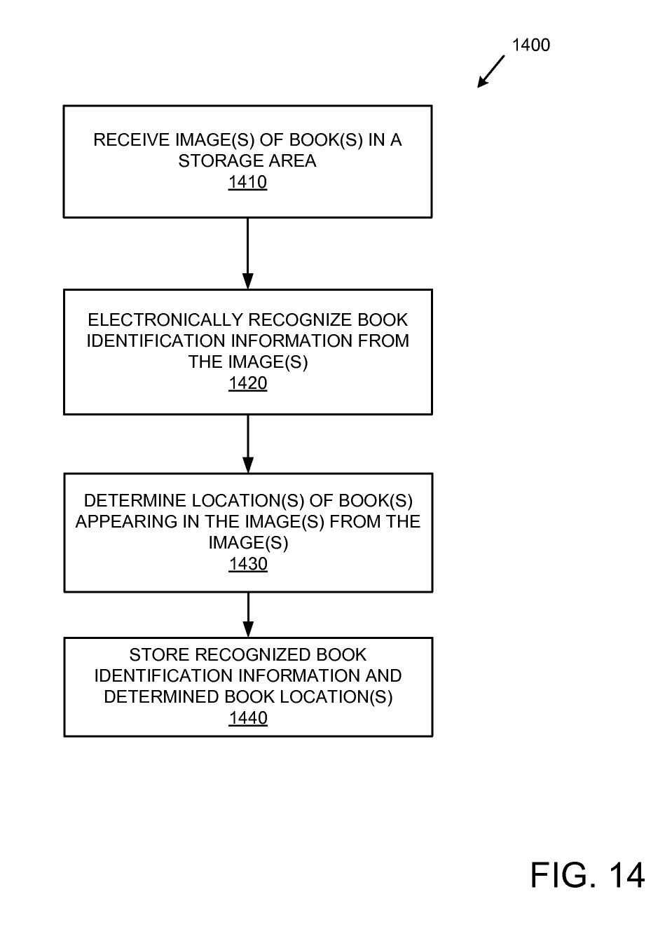

FIG. 14 is a flowchart of an exemplary method 1400 of storing identification information and locations that can be used in any of the examples herein.

At 1410, image(s) of book(s) in a storage area are received.

At 1420, identification information of the book(s) in the image(s) is electronically recognized from the image(s).

At 1430, the location(s) of the book(s) in the image(s) are determined from the image(s).

At 1440, book identification information and determined location(s) are stored.

### Example 26

### Exemplary Library Audit System

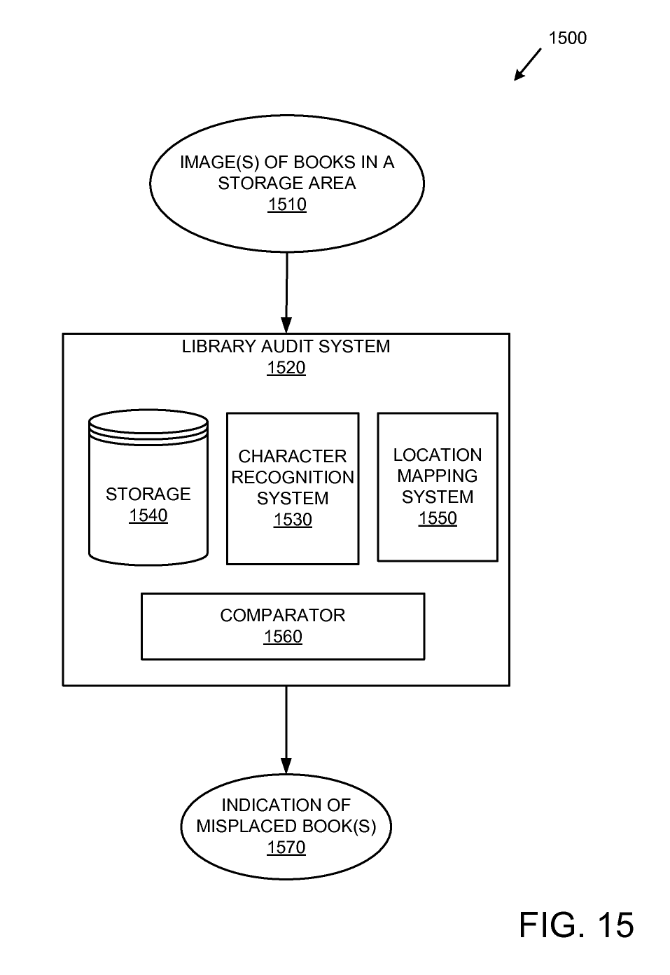

FIG. 15 is a block diagram of an exemplary system 1500 implementing a library audit system 1520.

The library audit system 1520 receives image(s) 1510 of books in a storage area. A character recognition system 1530 processes the image(s) 1510 to electronically recognize identification information appearing on the books in the image(s). The character recognition system 1530 can determine locations of books within the image(s). A location mapping system 1550 can map the locations of the books within the images to locations of the books in the storage area. A comparator 1560 compares determined locations to designated locations of the books in the storage area. The designated locations can be stored in a storage 1540 (e.g., database, XML, or the like). The library audit system 1520 provides indications 1570 of misplaced books based on comparator 1560 results. For example, those determined locations that do not match designated locations can be flagged and provided to one or more users as a list of locations of misplaced books. A list of determined locations of misplaced books can be used to update or replace a list of designated locations.

### Example 27

### Exemplary Method of Indicating Misplaced Items

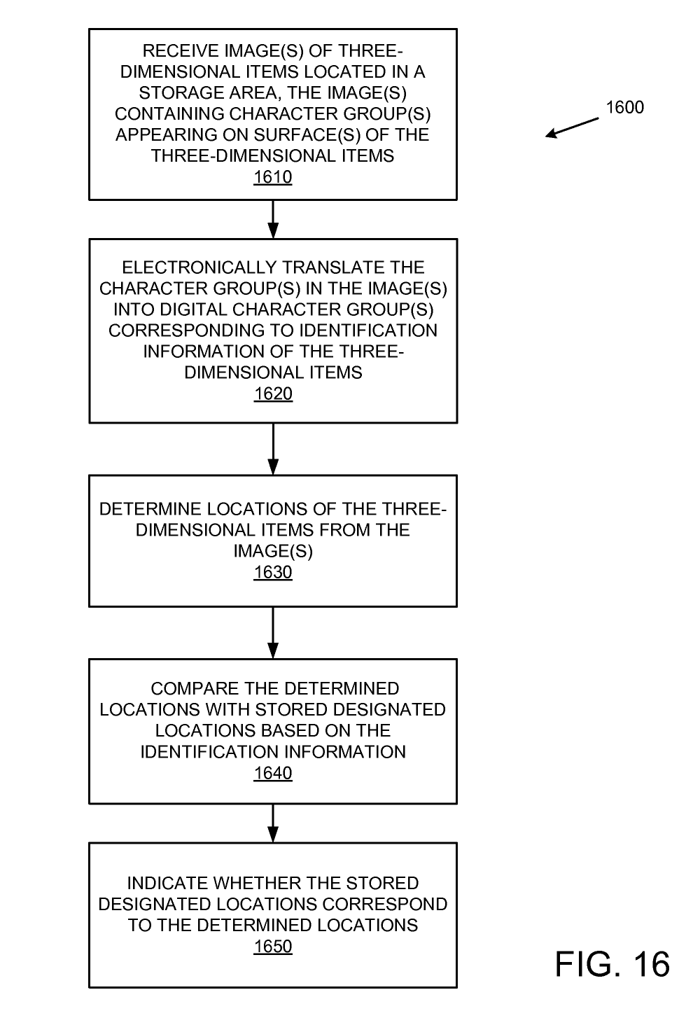

FIG. 16 is a flowchart of an exemplary method 1600 of indicating whether a three-dimensional item is misplaced and can be used in any of the examples herein.

At 1610, image(s) of three-dimensional items located in a storage area are received. The image(s) can contain character group(s) appearing on surface(s) of the three-dimensional items.

At 1620, character group(s) in the image(s) are electronically translated using character recognition methods into digital character group(s). The digital character group(s) correspond to identification information of the three-dimensional items appearing in the image(s).

At 1630, locations of the three-dimensional items appearing in the image(s) are determined from the image(s).

At 1640, determined locations are compared with stored designated locations based on the identification information. For example, the identification information can be a title of an item and the stored designated location can be retrieved from a database and sorted according to item title. In this example, a determined location for an item can be compared to a stored designated location that corresponds to an item with the same title.

At 1650, indications of whether the stored designated locations correspond to the determined locations are provided. For example, if a determined location for a first three-dimensional item appearing in the image(s) does not match a stored designated location for the first three-dimensional item, the first three-dimensional item will be indicated as corresponding to a misplaced item.

The method 1600 can be performed by a library audit system such as system 1500 for three-dimensional items such as books.

### Example 28

### Exemplary Book Replacement System

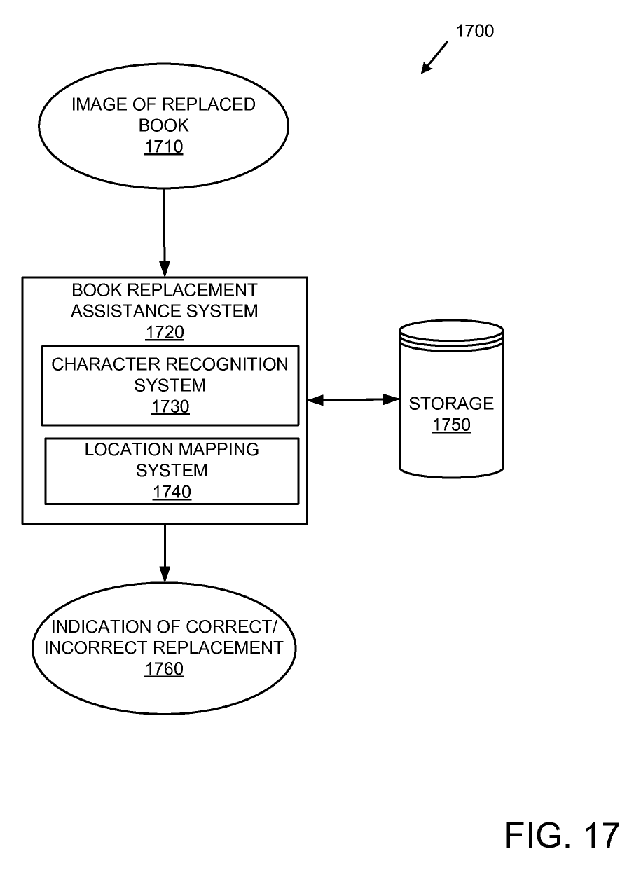

FIG. 17 is a block diagram of an exemplary system 1700 implementing a book replacement system 1720.

The book replacement system 1720 receives an image of a replaced book 1710. A character recognition system 1730 processes the image using character recognition methods. The character recognition system 1730 can determine identification information of the replaced book and a location for the replaced book within the image. A location mapping system 1740 can map the location of the replaced book within the image to a location of the replaced book within a book storage area.

The book replacement system 1720 can reference storage 1750 to retrieve a stored designated location for the replaced book and to determine whether the book has been correctly replaced. The book replacement system 1720 provides an indication 1760 of whether the replacement was correct or incorrect. For example, if the designated location of the replaced book does not match the determined location, the indications will be that the book has been misplaced or incorrectly replaced.

### Example 29

### Exemplary Method of Indicating Misplaced Books

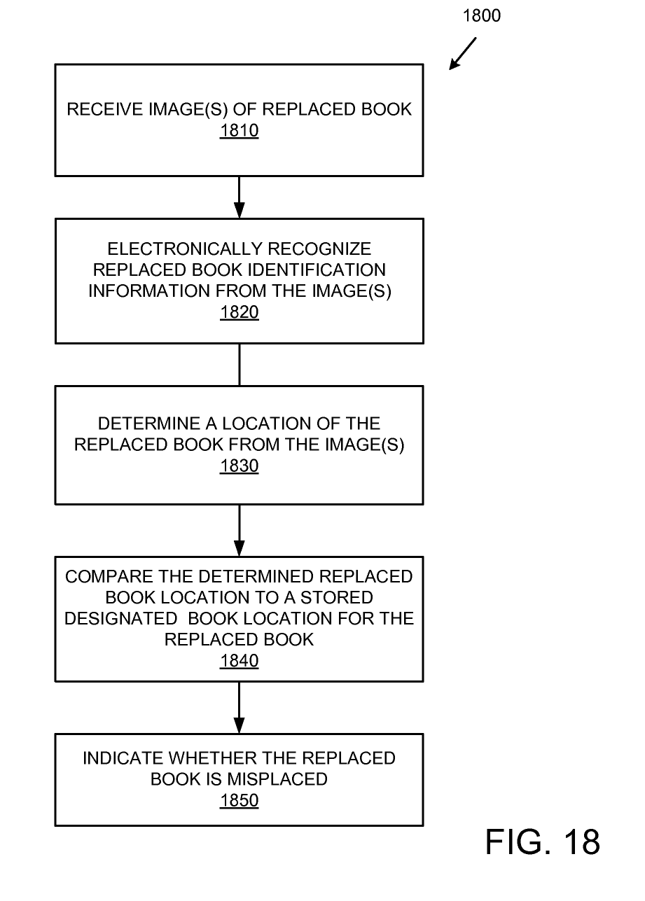

FIG. 18 is a flowchart of an exemplary method 1800 of indicating whether a book is misplaced.

At 1810, image(s) of a replaced book are received.

At 1820, identification information of the replaced book is electronically recognized from the image(s) using character recognition methods.

At 1830, a location of the replaced book is determined from the image(s).

At 1840, the determined location for the replaced book is compared to a designated location. The designated location indicates where in a storage area the replaced book is designated to be located.

At 1850, an indication of whether the replaced book is misplaced is provided.

### Example 30

### Exemplary Computing Environment

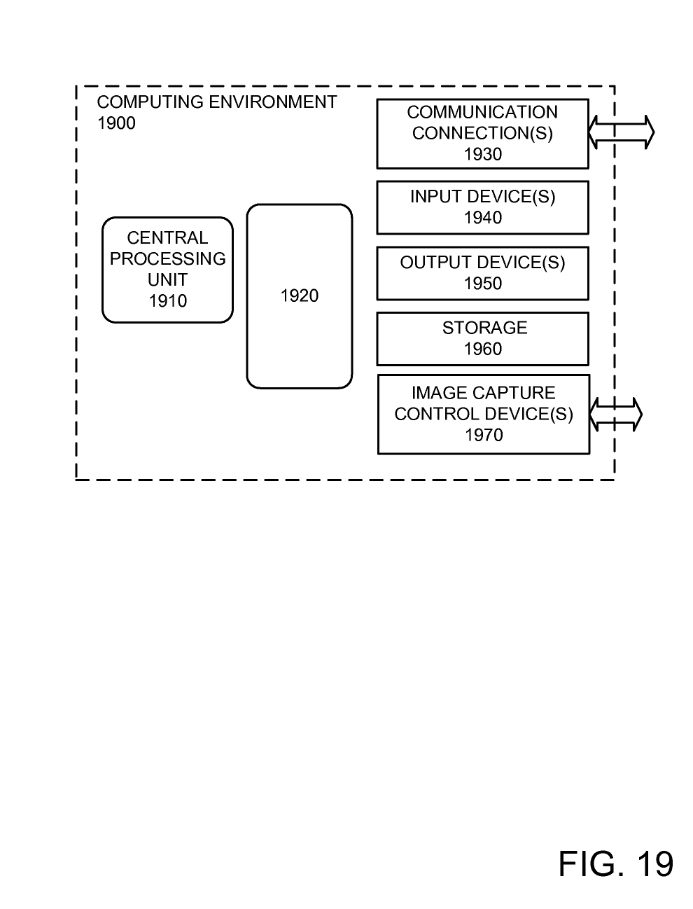

FIG. 19 illustrates a generalized example of a suitable computing environment 1900 in which the described techniques can be implemented. For example, computing and processing devices (e.g., physical machines) described herein can be configured as shown in the environment 1900. The computing environment 1900 is not intended to suggest any limitation as to scope of use or functionality, as the technologies can be implemented in diverse general-purpose or special-purpose computing environments. Mobile computing devices can similarly be considered a computing environment and can include computer-readable media. A mainframe environment can be different from that shown, but can also implement the technologies and can also have computer-readable media, one or more processors, and the like.

With reference to FIG. 19, the computing environment 1900 includes at least one processing unit 1910 and memory 1920. The processing unit 1910 executes computer-executable instructions and can be a real or a virtual processor. In a multi-processing system, multiple processing units execute computer-executable instructions to increase processing power. The memory 1920 can be volatile memory (e.g., registers, cache, RAM), non-volatile memory (e.g., ROM, EEPROM, flash memory, etc.), or some combination of the two. The memory 1920 can store software implementing any of the technologies described herein.

A computing environment can have additional features. For example, the computing environment 1900 includes storage 1960, one or more input devices 1940, one or more output devices 1950, one or more image capture control devices 1970, and one or more communication connections 1930. An interconnection mechanism (not shown) such as a bus, controller, or network interconnects the components of the computing environment 1900. Typically, operating system software (not shown) provides an operating environment for other software executing in the computing environment 1900, and coordinates activities of the components of the computing environment 1900.

The storage 1960 can be removable or non-removable, and includes magnetic disks, magnetic tapes or cassettes, CD-ROMs, DVDs, or any other computer-readable media which can be used to store information and which can be accessed within the computing environment 1900. The storage 1960 can store software containing computer-executable instructions for any of the technologies described herein.

The input device(s) 1940 can be any of the exemplary input devices described herein or any device that provides input to the computing environment 1900. The output device(s) 1950 can be any of the devices described herein or another device that provides output from the computing environment 1900. The image capture control device(s) 1970 can be any device for controlling an image capture device. The image capture control device(s) 1970 can control the image capture device through communication connections or image capture devices described herein can be incorporated into the image capture control device(s) 1970.

The communication connection(s) 1930 enable communication over a communication medium to another computing entity. The communication medium conveys information such as computer-executable instructions, audio/video or other media information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

Communication media can embody computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Communication media include wired media such as a wired network or direct-wired connection, and wireless media such as acoustic, RF, infrared and other wireless media. Combinations of any of the above can also be included within the scope of computer readable media.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules can be combined or split between program modules as desired in various embodiments. Computer-executable instructions for program modules can be executed within a local or distributed computing environment.

### Example 31

### Exemplary Electronic Locator Device

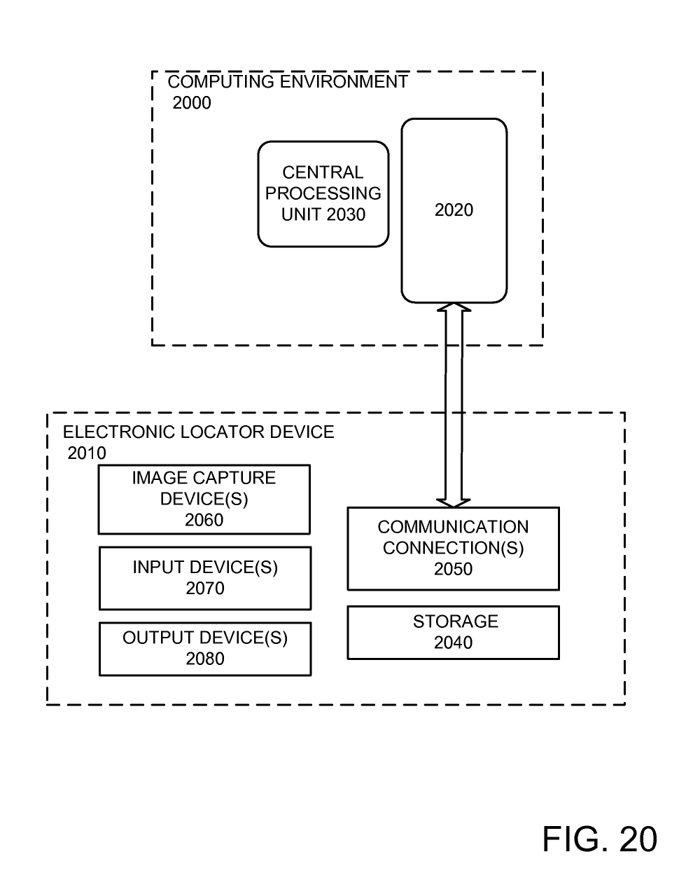

FIG. 20 illustrates an exemplary electronic locator device 2010 in communication with a computing environment 2000. The computing environment 2000 includes at least one processing unit 2030 and memory 2020. The processing unit 2030 executes computer-executable instructions and can be a real or a virtual processor. In a multi-processing system, multiple processing units execute computer-executable instructions to increase processing power. The memory 2020 can be volatile memory (e.g., registers, cache, RAM), non-volatile memory (e.g., ROM, EEPROM, flash memory, etc.), or some combination of the two. The memory 2020 can store software implementing any of the technologies described herein. An interconnection mechanism (not shown) such as a bus, controller, or network interconnects the components of the computing environment 2000. Typically, operating system software (not shown) provides an operating environment for other software executing in the computing environment 2000, and coordinates activities of the components of the computing environment 2000.

The computing environment 2000 can be connected through communication connections 2050 to the electronic locator device 2010. The electronic locator device 2010 can include storage 2040, one or more input devices 2070, one or more output devices 2080, and one or more image capture devices 2060. The storage 2040 can be removable or non-removable, and includes magnetic disks, magnetic tapes or cassettes, CD-ROMs, DVDs, or any other computer-readable media which can be used to store information. For example, the storage 2040 can store images captured by the image capture device(s) 2060, input from the input device(s) 2070, or configurations and instructions for the image capture device(s) 2060.

The input device(s) 2070 can be any of the devices described herein or another device that provides input to the electronic locator device 2010. The output device(s) 2080 can be any of the devices described herein or another device that provides output from the electronic locator device 2010. The image capture devices 2060 can be any image capture device as described herein or other device that captures images.

The communication connection(s) 2050 enable communication over a communication medium between the computing environment 2000 and the electronic locator device 2010. The communication medium conveys information such as computer-executable instructions, audio/video or other media information, or other data in a modulated data signal. A modulated data signal is a signal that has one or more of its characteristics set or changed in such a manner as to encode information in the signal. By way of example, and not limitation, communication media include wired or wireless techniques implemented with an electrical, optical, RF, infrared, acoustic, or other carrier.

The electronic locator device 2010 and/or the computing environment 2000 can be portable, handheld, movable, or stationary.

### Example 32

### Exemplary Electronic Locator Device Implementation

In an exemplary implementation of an electronic locator device, a user enters a library and obtains a handheld electronic locator device. The handheld electronic locator device includes an input device, an image capture device, and an output device. These devices can be separate devices or they can be incorporated into a single device. The handheld device can function using a point and search mechanism. The user enters identification information for a target book into the input device of the electronic locator device. For example, the user can type a book title into the handheld electronic locator device using a keypad or the user can speak a book title into a voice recognition system input device. The book identification information can be transmitted to a server or to a remote processor via conventional wireless data transfer mechanisms. The image capture device can capture images of a portion of the library where the user is holding the electronic locator device. For example, the user can be pointing the device at an aisle in the library. The aisle can contain several books that are arranged on shelves in a conventional manner. The image capture device can capture images of spines of the books on the shelves.

The images are transmitted to the server and identification information for the books appearing in the images is electronically recognized. For example, book titles can appear on the spines of the books in the images and character recognition methods can be used to process the images. The titles can be electronically translated into computer-editable text or digital character groups using the character recognition methods.

The user can move through the library while holding the handheld electronic locator device. As the user moves, the image capture device can continue to capture images of the books in the library and to transmit the images to the server. The server continues to process the images to recognize identification information for books in the images. The server also compares the recognized identification information to the identification information of the target book. For example, if the recognized identification information is a title of a book, the server compares the recognized title to the title of the target book. Once the recognized identification information matches the target book, the server sends an acknowledgement message to the handheld device.

The output device then notifies the user that the target book has been found. The user can be notified using various indication methods. For example, the electronic locator device can beep, play a recorded voice, activate a light source, or display an image to indicate that the book has been found. The device can also use indication methods described herein to indicate a location of the target book. For example, the output device can be an LCD screen which is configured to display the images captured by the image capture device. The location of the target item can be indicated on such an image.

### Example 33

### Exemplary Electronic Locator Device Implementation

In an exemplary implementation of an electronic locator device, a handheld electronic locator device includes an input device, an image capture device, an output device, and a server. This implementation of the electronic locator device is similar to the implementation described in Example 32 except wireless transfer mechanisms between the book locator device and a remote server may not be needed. For example, the server can be integrated into the handheld electronic locator device. In this example, image processing and data comparison can be performed by the handheld electronic locator device instead of by a remote server.

### Example 34

### Exemplary Electronic Locator Device Implementation

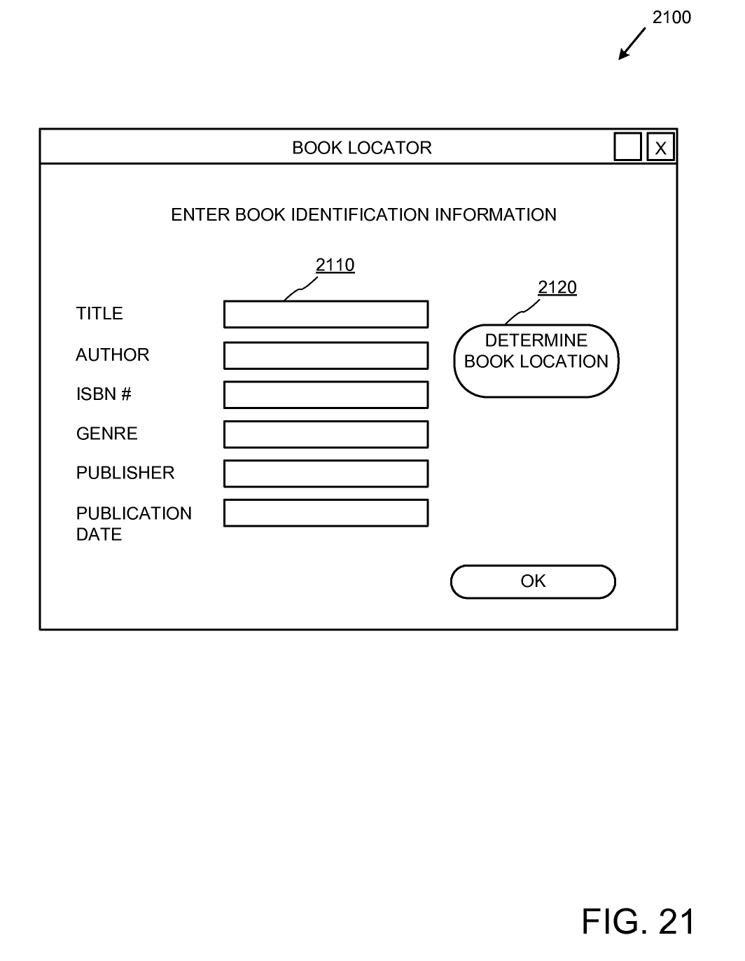

In an exemplary implementation of an electronic locator device, a user enters a library and inputs identification information for a target book into an input device at a work station. The target book can be a book that a user wants to locate. The work station can be an exemplary computing environment as described herein. For example, the work station can be a computer system at a receptionist desk and the user can type a title for the target book into the computer using a keyboard. FIG. 21 shows an example screenshot 2100 that can be used to enter identification information for a target book into a computer. In the example screenshot, book identification information 2110 is entered by a user. The book location is determined after the user activates button 2120.

To determine the location of the target book, the work station can command one or more image capture devices located in the library to capture images of books in the library. The work station can be configured to access a database or other storage containing identification information and designated locations for books in the library. Based on the input data, the work station can retrieve a stored designated location for the target book. The work station can provide the designated location to the one or more users or the work station can command image capture devices located throughout the library to capture one or more images of the designated location. Captured images can be sent to a server or a processor via a wireline or wireless data transfer mechanisms. The server can be connected to the work station or otherwise receive the input data from the work station.

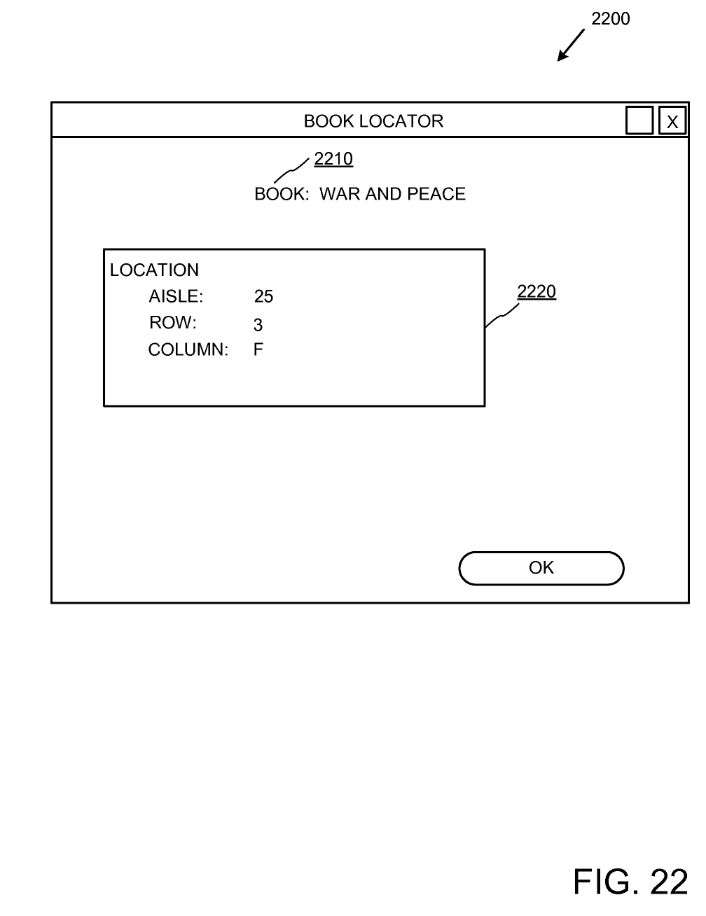

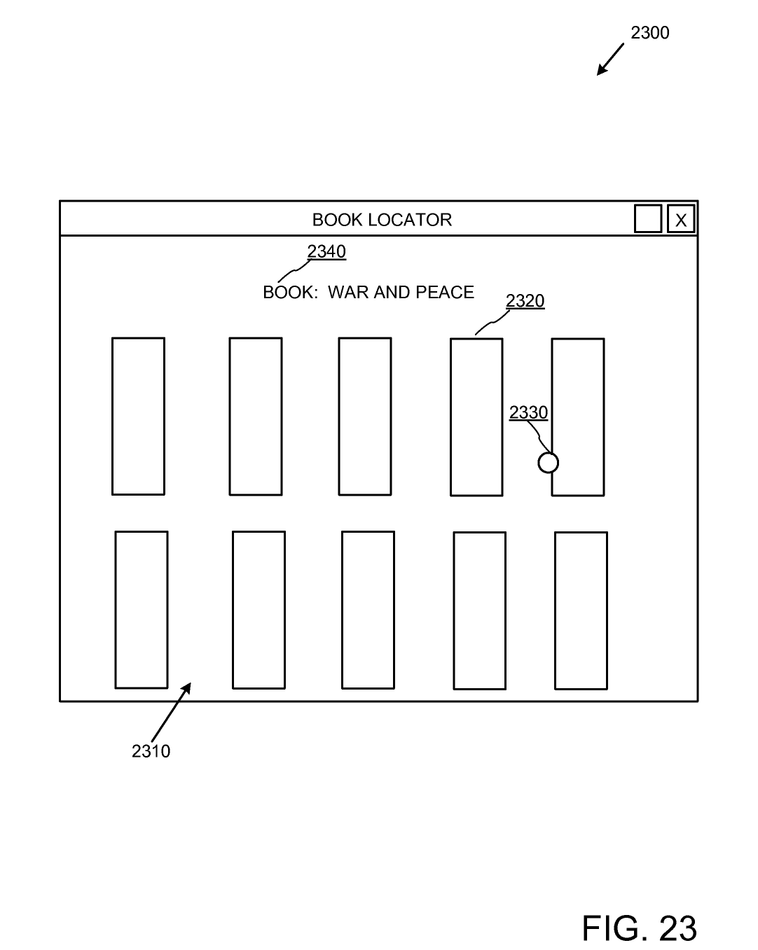

The server processes the images using character recognition methods to determine identification information for books in the images. The server then compares recognized identification information for the books in the images to the identification information of the target book. If there is a match between the recognized identification information and the identification information of the target book, the server can determine the location of the target book from the images and verify that the designated location is the same as the determined location. The location of the target book can be indicated for a user by an output device at the work station. The output device can direct the user to the location in the library where the target book can be found. For example, an address for the target book can be displayed on a computer monitor. FIG. 22 shows an example screenshot 2200 that can be used to provide a location of the target book in the library to a user. In the example, the address information 2220 for a located book 2210 is displayed. FIG. 23 shows an example screenshot 2300 that can be used for indicating a location of the target book 2340 using an illustration of a floor plan of a book storage area 2310. In the example, shelves 2320 of the book storage area are displayed to illustrate the floor plan of the book storage area 2310 and a location of the target book is indicated by a circle 2330

If the determined identification information does not match the identification information of the target book, one or more additional images of the library can be captured and processed in a similar manner until a match is found. For example, a previous library user may have replaced the target book incorrectly in a location other than the designated location. In this example, a match will not be found until an image of the incorrect location is processed. Once a match is found, the server can determine the location of the target book from the additional images and indicate the location of the target book using indications described herein.

### Example 35

### Exemplary Electronic Database Creator

In an exemplary implementation of an electronic database creator, a database can be created from images of books. For example, a user can position a book in front of an image capture device, or the user can position an image capture device in front of the book. The image capture device captures an image of the book. The image capture can be triggered automatically by a motion detector. For example, the book can be positioned in front of a white background such that the image capture device can detect the presence of the book. The image capture can also be triggered manually such as via a computer. The image can be transmitted to a server. The server can process the image using character recognition methods to electronically recognize identification information appearing in the image of the book. The recognized information can be stored such as in a library database. A database can be a flat file or a large relational database.

### Example 36

### Exemplary Electronic Database Creator

In an exemplary implementation of an electronic database creator one or more image capture devices are positioned throughout a storage area to be inventoried. The one or more image capture devices can be movable or stationary. The image capture devices can be positioned such that substantially all items to be inventoried can be imaged by the image capture devices. For example, several cameras can be located throughout a library or one or more cameras can be moved either automatically or manually through the library.

The image capture devices capture images of the items in the storage area. The image capture can be triggered manually such as via a computer or image capture can be scheduled to occur at predetermined times. The images can be transmitted to a server. The server processes the images using character recognition methods to electronically recognize identification information for the items in the images. The server can determine locations of the items in the storage area based on the images. The recognized information and the determined locations can be stored such as in a database. A database can be any type of suitable database. For example, the database can be a flat file or a relational database. The recognized information and the determined locations can be stored in any exemplary storage described herein. Stored recognized information and determined locations can be used to update another database. For example, a book store can create a database of book titles and book locations periodically during a business day such that stored book locations can be more reliable.

Through use of such an electronic database creator, item names and other identification information and item locations can be collected and stored without the need for manual entry of such information. For example, a handheld electronic database creator can be pointed at a book and a book title and a book location can be automatically added to a database.

### Example 37

### Exemplary Book Replacement System

In an exemplary implementation of a book replacement system, a user in a library can be replacing a book, and the book replacement system can assist the user in replacing the book in the correct location.

First, the book to be replaced is identified or recognized by the system. The user can type or otherwise input book identification information into the system, or the user can position the book to be replaced in front of an image capture device connected to a server. The image capture device can be located at a work station or in an aisle of the library and can capture an image of the book to be replaced. The image is sent to the server, and the server processes the image to determine identification information of the book to be replaced, such as a book title or a book bar code, from the image. The book can also be identified by an RFID tag attached to the book. Based on the recognized information, a stored location for the book to be replaced can be output to the user or otherwise indicated for the user using location indications described herein.

The book to be replaced can be automatically identified when the user places the book on a shelf. For example, the shelf can be configured to sense book movement such as with motion sensors or weight sensors. The replacement of the book can trigger an image capture device to capture an image of the replaced book and to send the image to a server. The image can be processed using character recognition methods described herein to recognize identification information of the book. The location of the replaced book can also be determined using location determining methods described herein. The recognized location can be compared to a stored location based on the recognized identification information.

If the recognized location does not match the stored location, the book has been incorrectly replaced. The book replacement system can indicate to the user that the book replacement is incorrect. For example, a recorded voice may inform the user that the replacement is incorrect and the correct location can be indicated. The book replacement system can also replace the stored location with the recognized location.

### Example 38

### Exemplary Audit System

In an exemplary implementation of an audit system, a user triggers a library audit using an input device. The input device can be attached to a work station such as a computer system. One or more image capture devices are positioned in the library to be audited. Preferably, the image capture devices are positioned such that substantially all books to be audited in the library can be imaged by the image capture devices. For example, several cameras can be located throughout the library or one or more cameras can be moved through the library.

The image capture devices capture images of the books in the library and transmit the images to a server. The server processes the images using character recognition methods to electronically recognize identification information for the books in the images. The server can determine locations of the books in the library based on the images using technologies described herein. The recognized identification information and the determined locations can be stored such as in a database. The determined locations can be compared to stored designated locations based on the recognized identification information. If a determined location does not match a designated location, the book can be electronically tagged. A list of tagged books can be output to a user.

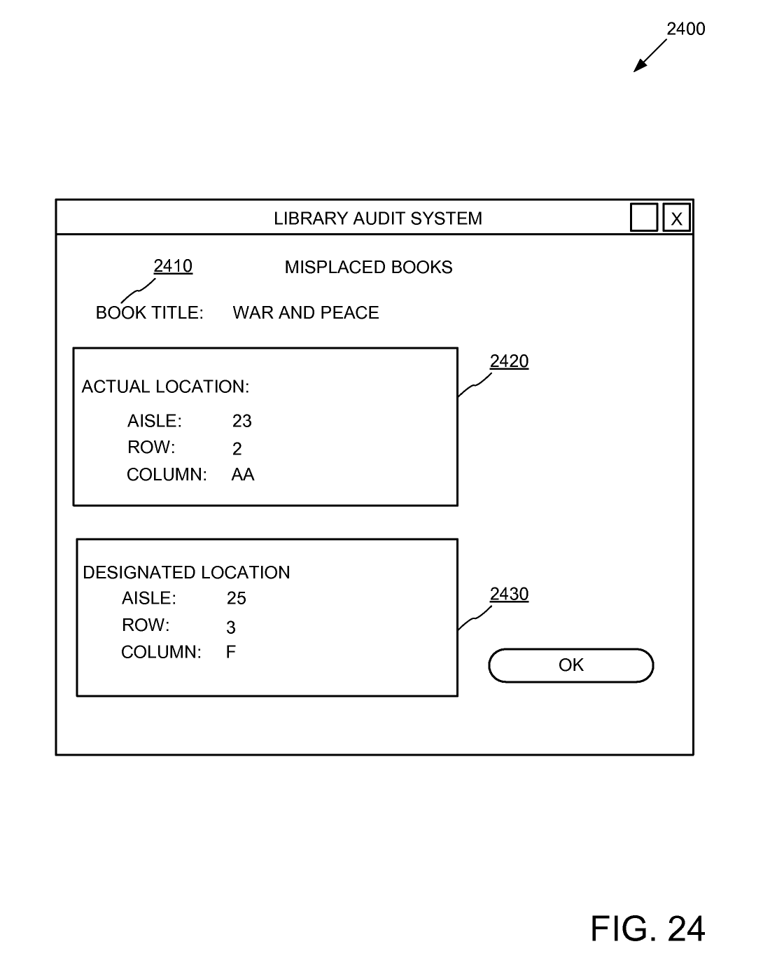

FIG. 24 shows an example screenshot 2400 that can be used to display misplaced books for a user. In the example, an address for the designated location 2430 of a misplaced book 2410 is shown along with an address for the actual (incorrect) location 2420 of the misplaced book. Each misplaced book can be displayed individually or a list of misplaced books and addresses can be displayed. The user can print out a list of addresses of misplaced books or misplaced books can be indicated by other visual cues. For example, light sources such as LEDs can be distributed in the library and can be illuminated to indicate a misplaced book. The user can then rearrange the misplaced books into their designated locations.

A list of misplaced books can be used to update or to replace a database or other stored list of designated locations for books in a library.

### Example 39

### Exemplary Book Locator

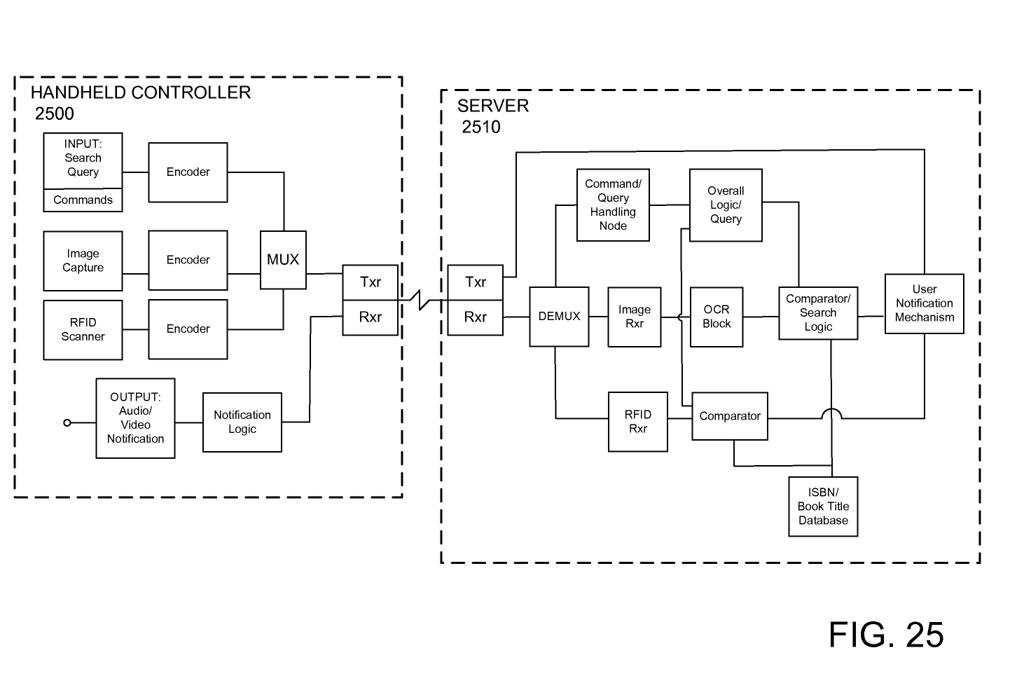

FIG. 25 is a block diagram of a book locator with optional RFID. The diagram is a schematic representation of a book search mechanism with the option of an RFID based search. The schematic representation includes mechanisms performed by a handheld controller and a server. In FIG. 25, the mechanisms performed by the handheld controller appear in dashed box 2500 while the mechanisms performed by the server appear in dashed box 2510.

Blocks Txr and Rxr indicate transmission and reception, respectively, of information or data between the handheld controller 2500 and the server 2510. The handheld controller 2500 contains an input mechanism, an output mechanism, and an image capturing mechanism represented by block Image Capture. The handheld controller can also include an RFID scanner mechanism represented by block RFID Scanner. The input mechanism can receive information such as a book name to be searched or other search query. The input mechanism can also receive other commands. The output mechanism can be an audio/video notification mechanism. Data from the input mechanism, the image capture mechanism, and the optional RFID mechanism are combined at a block MUX. The block MUX multiplexes data from the three mechanisms. The MUX can be a separate device or the MUX mechanism can be performed by another device. Data is transmitted from the MUX to the server 2510 through block Txr. The output mechanism, or audio/video notification mechanism, can output information received from the server 2510 through block Rxr.

Data is received by the server 2510 from the MUX block of the handheld controller through block Rxr. The data is demuxed at block DEMUX and sent to appropriate blocks. For example, a book name is sent to a “Command query handling node” block, RFID tag data is sent to an RFID value receiver at block RFID Rxr, and image data is sent to an image receiver at block Image Rxr. The image receiver processes image data at block OCR using character recognition methods described herein to recognize identification information of a book from an image of the book. The Overall Logic/Query block provides the name of the searched book or other queried information. The Comparator/Search Logic block compares data received from the OCR block to data from the Query block. The Comparator/Search Logic block can use database data from block ISBN/Book Title Database to fill in missing characters in recognized information in the OCR block data. RFID data from the RFID receiver can be compared to data from the Query block at block Comparator.

RFID data comparison and image data comparison can be used simultaneously, consecutively, or alternatively. If a user notification mechanism is enabled, the user notification mechanism can send results from the comparison to the handheld controller 2500. Depending on the received signal through block Rxr of the handheld controller 2500, an audio/video notification can be created to indicate a location of a book.

### Example 40

### Exemplary Book Locator with Sorting

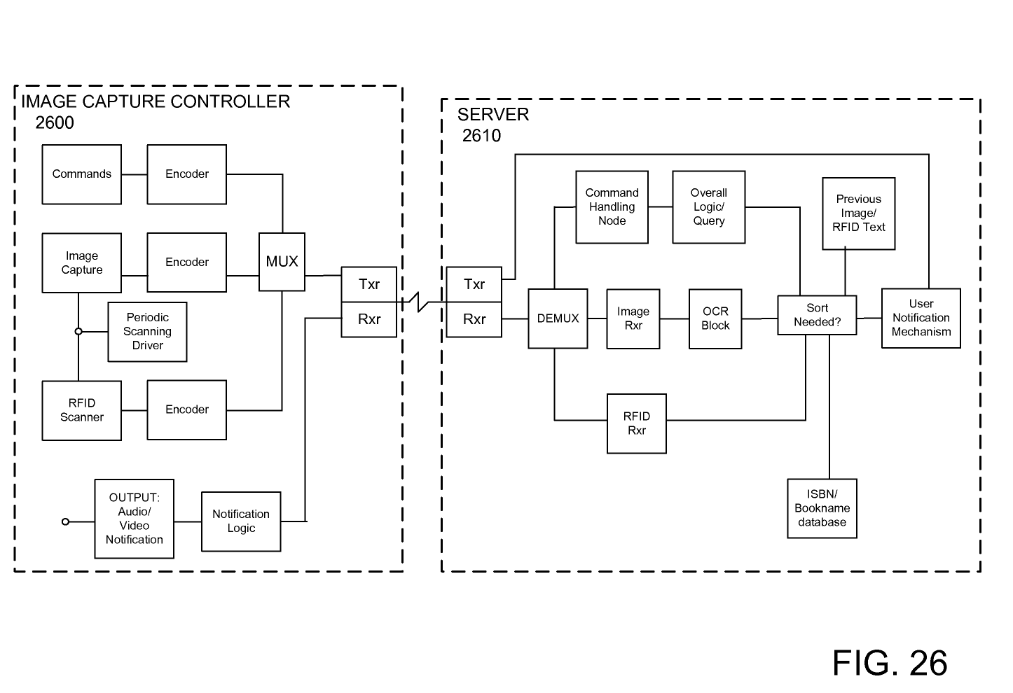

FIG. 26 is a block diagram of a book locator with automatic sort and with optional RFID. The diagram is a schematic representation of a book search mechanism with the option of an RFID based search and a sorting mechanism. The schematic representation includes mechanisms performed by an image capture controller and a server. In FIG. 26, the mechanisms performed by the image capture controller appear in dashed box 2600 while the mechanisms performed by the server appear in dashed box 2610.

Blocks Txr and Rxr indicate transmission and reception, respectively, of information or data between the image capture controller 2600 and the server 2610. The image capture controller 2600 contains an image capturing mechanism represented by block Image Capture, a mechanism to invoke commands represented by block Commands, and an output mechanism. The image capture controller can include an optional RFID scanner. The mechanism to invoke commands can be used to control auditing and sorting. A periodic scanning driver mechanism can be used to drive image capture and RFID scanning over periodic intervals. The scanning driver mechanism, image capture mechanism, and/or RFID scanner can be controlled by control commands not shown. The output mechanism can be an audio/video notification mechanism. Data from the command invoking mechanism, image capture mechanism, and optional RFID mechanism are combined at a block MUX. The block MUX multiplexes data from the three mechanisms. The MUX can be a separate device or the MUX mechanism can be performed by another device. Data is transmitted from the MUX to the server 2610 through block Txr. The output mechanism, or audio/video notification mechanism, outputs information received from the server 2610 through block Rxr.

Data is received by the server 2610 through block Rxr. The data is demuxed or decoded at block DEMUX and sent to appropriate blocks. For example, commands are sent to a “Command handling node” block, RFID tag data is sent to an RFID value receiver at block RFID Rxr, and image data is sent to an image receiver at block Image Rxr. The image receiver processes image data at block OCR using character recognition methods described herein to recognize identification information of a book from an image of the book.

Whether sorting is needed is determined at block “Sort needed?” based on previous image/text data, data from block OCR, data from RFID receiver block, data from a book database, and command data. For example, previous image/text data is provided to block “Sort needed?” and compared to data from block OCR to determined if a new image is being processed. If the previous image data is not different from the OCR data, then sorting is not needed. Data from the book database is compared at the block “Sort needed?” to data from block OCR (and/or data from the RFID receiver block) and a sort is needed if the data doesn't match. The “Sort needed?” block can use database data for the comparison. Depending on whether the sort is needed, a notification can be sent to the user through a User Notification Mechanism. The User Notification Mechanism can transmit the notification to the image capture controller 2600.

### Exemplary Applications

Any of the examples herein can be applied in the area of item storage, inventory, and organization. Examples described herein can also be applied in other areas where an electronic system for locating, listing, and cataloguing items is desired. In addition, the technologies described herein can be used in combination with other such systems.

### Methods in Computer-Readable Media

Any of the methods described herein can be implemented by computer-executable instructions in one or more computer-readable media (e.g., computer-readable storage media, other tangible media, or the like). Such computer-executable instructions can cause a computer to perform the described method.

### Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims. I therefore claim as my invention all that comes within the scope and spirit of these claims.

I claim:

1. A computer-implemented method comprising:
receiving data corresponding to a title of a target book located in a book storage area;
receiving at least one image of at least one book spine of at least one book located in a first portion of the book storage area;
electronically recognizing at least one book title appearing on the at least one book spine by processing the at least one image using character recognition methods;
comparing the at least one recognized book title to the title of the target book; and
based on the comparing, indicating whether the target book is located in the first portion of the book storage area.

2. The method of claim 1, further comprising:
determining a location of the target book based on the at least one image; and
indicating the location of the target book.

3. The method of claim 2, wherein determining the location of the target book comprises:
determining a location of the target book within the at least one image; and
mapping the location of the target book within the at least one image to a location in the first portion of the book storage area.

4. The method of claim 2, wherein indicating the location of the target book comprises:
displaying the at least one image; and
marking a location of the target book within the at least one image on the displayed at least one image.

5. The method of claim 2, wherein indicating the location of the target book comprises:
providing auditory cues to one or more users, the provided auditory cues directing the one or more users to a location of the target book within the first portion of the book storage area.

6. The method of claim 2, wherein indicating the location of the target book comprises providing an address corresponding to a location of the target book in the first portion of the book storage area.

7. The method of claim 2, wherein indicating the location of the target book comprises displaying an indication of the location on a software-driven user interface.

8. The method of claim 2, further comprising:
storing the determined location of the target book.

9. The method of claim 1, wherein processing the at least one image using character recognition methods comprises referencing a stored list comprising titles of books in the book storage area.

10. The method of claim 1, further comprising:
receiving at least one image of at least one book spine of at least one book located in a second portion of the book storage area; and
indicating whether the target book is located in the second portion of the book storage area.

11. A system for finding books comprising:
an input device configured to accept data corresponding to a title of a target book located in a book storage area;
an image capture control device configured to activate one or more image capture devices to capture images of spines of books located in a first portion of the book storage area;
a processor configured to receive the data from the input device, to receive the images from the one or more image capture devices, and to process the images using character recognition methods to electronically recognize book titles appearing in the images;
a comparator configured to compare the recognized book titles to the title of the target book; and
an output device configured to indicate, based on results of the comparing, whether the target book is located in the first portion of the book storage area.

12. The system of claim 11, wherein the output device is configured to be movable within the book storage area.

13. The system of claim 11, wherein the image capture control device is further configured to control a system of image capture devices positioned throughout the book storage area configured to capture images of spines of books located in the book storage area, the system comprising the one or more image capture devices.

14. The system of claim 11, wherein the one or more input devices are configured to be movable within the book storage area.

15. An apparatus comprising:
means for receiving data corresponding to a title of a target book located in a book storage area;
means for receiving at least one image of at least one book spine of at least one book located in a first portion of the book storage area;
means for electronically recognizing at least one book title appearing on the at least one book spine by processing the at least one image using character recognition methods;
means for comparing the at least one recognized book title to the title of the target book; and
means for indicating whether the target book is located in the first portion of the book storage area based on the comparison.

16. A computer-implemented method comprising:
receiving at least one image of at least one character group appearing on a surface of at least one three-dimensional item located in a storage area, wherein the at least one character group corresponds to identification information of the at least one three-dimensional item;
electronically translating the at least one image of the at least one character group into at least one corresponding digital character group using character recognition methods;
determining a location in the storage area of the at least one three-dimensional item based on the at least one image;
comparing the determined location of the at least one three-dimensional item with a stored designated location indicative of a location in the storage area where the at least one three-dimensional item is designated to be located based on the identification information of the at least one three-dimensional item; and
indicating whether the stored designated location corresponds to the determined location.

17. The method of claim 16, wherein the at least one character group corresponds to at least one word appearing on the surface of the at least one three-dimensional item located in the storage area.

18. The method of claim 16, wherein the identification information comprises a title of the at least one three-dimensional item.

19. The method of claim 16, wherein:
the at least one three-dimensional item comprises a book;
the at least one character group appears on a spine of the book; and
the book is arranged on a shelf adjacent to other books.

20. The method of claim 16, wherein determining the location in the storage area of the at least one three-dimensional item comprises:
determining a location of the at least one three-dimensional item within the at least one image; and
mapping the location of the at least one three-dimensional item within the at least one image to the location in the storage area.

21. The method of claim 16, wherein the indicating comprises providing audible beeps.

22. The method of claim 16, wherein the indicating comprises providing an address for the at least one three-dimensional item indicative of the determined location of the at least one three-dimensional item in the storage area.

23. The method of claim 16, further comprising:
storing the determined location.

24. The method of claim 16, wherein the at least one three-dimensional item is a plurality of three-dimensional items, wherein determining a location comprises determining corresponding locations in the storage area of the plurality of three-dimensional items, and wherein comparing is performed by comparing a stored list of designated locations for the plurality of three-dimensional items to a list of the determined corresponding locations.

25. A system comprising:
one or more image capture devices configured to capture images of three-dimensional items in a storage area, the three-dimensional items having identification information appearing on surfaces of the three-dimensional items appearing in the images, the identification information comprising titles of the three-dimensional items;
a processor configured to receive the images, to process the images using character recognition methods to electronically recognize the identification information of three-dimensional items appearing in the images, wherein the recognized identification information comprises recognized titles of the three-dimensional items appearing in the images, to determine locations within the images for the three-dimensional items appearing in the images, and to map the locations within the images to locations in the storage area;
storage configured to store designated locations of the three-dimensional items in the storage area, the designated locations indicative of locations in the storage area where the three-dimensional items are designated to be located, to store the recognized identification information of the three-dimensional items appearing in the images, and to store the locations in the storage area of the three-dimensional items appearing in the images;
a comparator configured to compare the locations in the storage area of the three-dimensional items appearing in the images with stored designated locations of corresponding three-dimensional items based on the recognized identification information, corresponding three-dimensional items having titles that correspond to the recognized titles, and to determine whether the stored designated locations of the corresponding three-dimensional items correspond to the locations in the storage area of the three-dimensional items appearing in the images; and
an output device configured to indicate, based on comparator results, those locations in the storage area of the three-dimensional items appearing in the images which do not correspond to the stored designated locations of the corresponding three-dimensional items.
